(19) United States
(12) Patent Application Publication
(10) Pub. No.: US 2013/0318544 A1
(43) Pub. Date: Nov. 28, 2013

(54) PROGRAM GENERATION DEVICE, PROGRAM GENERATION METHOD, PROCESSOR DEVICE, AND MULTIPROCESSOR SYSTEM

(71) Applicant: PANASONIC CORPORATION, Osaka (JP)

(72) Inventors: Manabu KURODA, Hyogo (JP); Yoshihiro KOGA, Osaka (JP); Kunihiko HAYASHI, Osaka (JP); Kouji NAKAJIMA, Ibaraki (JP)

(73) Assignee: PANASONIC CORPORATION, Osaka (JP)

(21) Appl. No.: 13/953,203

(22) Filed: Jul. 29, 2013

Related U.S. Application Data
(63) Continuation of application No. PCT/JP2012/000348, filed on Jan. 20, 2012.

(30) Foreign Application Priority Data
Jan. 31, 2011 (JP) 2011-019171

(51) Int. Cl. G06F 9/54

(52) U.S. Cl. CPC G06F 9/54
USPC 719/320

(57) ABSTRACT

A program generation device for generating, from a source program, machine programs corresponding to a plurality of processors having different instruction sets and sharing a memory, the program generation device including: a switch point determination unit for determining a switch point in the source program; a switchable-program generation unit for generating a switchable program for each processor so that a data structure of the memory is commonly shared at a switch point among the plurality of processors; and a switch decision process insertion unit for inserting into the switchable programs a switch program for stopping at the switch point a switchable program being executed by and corresponding to a first processor, and causing a second processor to execute, from the switch point, a switchable program corresponding to the second processor.

### CROSS REFERENCE TO RELATED APPLICATION(S)

This is a continuation application of PCT Patent Application No. PCT/JP2012/000348 filed on Jan. 20, 2012, designating the United States of America, which is based on and claims priority of Japanese Patent Application No. 2011-019171 filed on Jan. 31, 2011. The entire disclosures of the above-identified applications, including the specifications, drawings and claims are incorporated herein by reference in their entirety.

### FIELD

The present invention relates to program generation devices, program generation methods, processor devices, and multiprocessors. In particular, the present invention relates to a program generation device, a program generation method, a processor device, and a multiprocessor system in a heterogeneous multi-processor system including a plurality of processors having different instruction sets and sharing a memory therebetween.

### BACKGROUND

Digital devices such as mobile phones and digital televisions often incorporate therein a processor specialized for a process required by individual function, to improve performance and achieve low power consumption. Examples of the processor specialized for a predetermined process include versatile central processing units (CPU) in a field of network browser process, digital signal processor (DSP) with enhanced signal processing in a field of sounds and images processing, and graphics processing unit (GPU) with enhanced image display processing in a field of subtitles and three-dimensional graphics display processing. Thus, it is common to configure a system which incorporates a processor optimized for each process at minimum cost.

Furthermore, in a system such as network video system in which a plurality of processes including network processing and video processing needs to be performed simultaneously for one function, the system often includes processors suitable for respective processes simultaneously. This can achieve a system at a minimum cost which can resist the maximum load at which all the processes are simultaneously in use.

Modern digital devices, however, are demanded to implement multiple functions in one system, and depending on the function in use, maximum performances of all the processors may not be necessarily required. For example, to play back music during network processing, the versatile CPU and DSP are simultaneously required. At a point when only music is played back, processing load increases primary only for the DSP.

Even if the processing load is small, however, it is necessary that processors performing processes that have respective properties are all energized, which is not advantageous in view of power consumption, as compared to a system that implements all by one processor. For music playback, for example, if system control is performed by the versatile CPU, although an Internet browser is terminated and the Internet processing is ended, the versatile CPU cannot be powered off despite that processing load required from the system control is small, ending up both the versatile CPU and the DSP being energized continuously.

In such a case, in recent years, to reduce the power it is proposed that processes are concentrated on one processor by the processor, as a proxy, executing a process of another processor, and the other processor is powered off.

For example, PTL 1 discloses a technique for achieving power saving or improvement in system processing efficiency in a system which includes a plurality of processors having different types. Specifically, the multiprocessor system disclosed in PTL 1 includes a GPU and a media processing unit (MPU). The multiprocessor system switches a first mode in which the MPU is caused to execute a first program module for causing the MPU to perform video image decoding, and a second mode, in which the GPU is caused to execute a second program module, for causing the GPU to perform video image decoding. The modes, here, are switched therebetween, based on conditions of battery, external power source, or the like.

### CITATION LIST

### Patent Literature

[PTL 1] Japanese Unexamined Patent Application Publication No. 2008-276395

### SUMMARY

### Technical Problem

In the above conventional technique, however, processors cannot be switched therebetween during execution of a task, and thus there arises a problem that the technique cannot accommodate changes in statuses of system and use case.

In general, a plurality of processors which has different instruction sets executes different machine programs. Therefore, although the final results match, processes through which the machine programs are executed are different. Thus, when the execution programs of two processors stop at corresponding locations and states of working memories are compared, the states of working memories in processes through which the execution programs are executed do not necessarily match. In other words, the processors cannot be switched therebetween during execution of a task.

As a result, in the case of an Internet browser and music playback, for example, even if the processing load on the versatile CPU is reduced due to the termination of Internet browser and the end of network processing, once the function of music playback is transferred to the versatile CPU, continuity of the process cannot be preserved. Therefore, a process such as temporarily stopping the music playback is required. Thus, the technique cannot accommodate changes in statuses of system and use case.

Hence, the present invention is made in view of the above problems and an object of the present invention is to provide a program generation device, a program generation method, a processor device, and a multiprocessor system which allow processors to be switched therebetween even during execution of a task, and can accommodate changes in statuses of system and use case.

### Solution to Problem

To solve the above problems, a program generation device according to one aspect of the present invention is a program generation device for generating, from a same source program, machine programs corresponding to plural processors having different instruction sets and sharing a memory, the program generation device including: a switch point determination unit configured to determine a predetermined location in the source program as a switch point; a program generation unit configured to generate for each processor a switchable program, which is the machine program, from the source program so that a data structure of the memory is commonly shared at the switch point among the plural processors; and an insertion unit configured to insert into the switchable program a switch program for stopping at the switch point a switchable program, among the switchable programs, being executed by and corresponding to a first processor that is one of the plural processors, and causing a second processor that is one of the plural processors to execute, from the switch point, a switchable program, among the switchable programs, corresponding to the second processor.

According to the above configuration, the data structure of the memory is commonly shared at the switch point. Thus, the processors can be switched therebetween by executing the switch program. Switching the processors therebetween, herein, is stopping a processor executing a program, and causing another processor to execute a program from the stopped point.

Thus, according to the program generation device of one aspect of the present invention, the second processor can continue the execution of a task being executed by the first processor. In other words, the execution processor suspends the processing in a state of data memory whereby another processor can continue the processing, and the other processor takes over the state of data memory and resumes processing at a corresponding program position in the program switched to, thereby continuing the processing while sharing the same data memory, keeping the consistency.

Moreover, the program generation device may further include a direction unit configured to direct generation of the switchable programs, wherein the switch point determination unit determines the switch point when the direction unit directs the generation of the switchable programs, the program generation unit generates the switchable programs when the direction unit directs the generation of the switchable programs, and the insertion unit inserts the switch program into the switchable programs when the direction unit directs the generation of the switchable programs.

According to the above configuration, the switchable programs can be selectively generated. For example, when the source program can be executed only by a specific processor, it is not necessary to generate the switchable programs. In such a case, throughput required for program generation can be reduced by not directing the generation of the switchable programs.

Moreover, when the direction unit does not direct the generation of the switchable programs, the program generation unit may generate for each processor a program which can be executed only by a corresponding processor among the plural processors, based on the source program.

According to the above configuration, the switchable programs can be selectively generated. For example, when the source program can be executed only by a specific processor, it is not necessary to generate the switchable programs. In such a case, throughput required for program generation can be reduced by not directing the generation of the switchable programs.

Moreover, the switch point determination unit may determine at least a portion of boundaries of a basic block of the source program as the switch point.

According to the above configuration, the basic block is a group of processes which include no branch nor merge in halfway through. Therefore, setting the boundaries of the basic block as the switch points can facilitate management of the switch points.

Moreover, the basic block is a subroutine of the source program, and the switch point determination unit may determine at least a portion of boundaries of the subroutine of the source program as the switch point.

According to the above configuration, determining a boundary of the subroutine as a switch point can facilitate the processor switching. For example, managing the branch target address to the subroutine and the return address from the subroutine in association between the processors can facilitate the continuation of the processing at the processor switched to.

Moreover, the switch point determination unit may determine a call portion of a caller of the subroutine as the switch point, the call portion being the at least a portion of the boundaries of the subroutine.

According to the above configuration, determining a boundary of the subroutine as the switch point can facilitate the processor switching. For example, managing the branch target addresses to the subroutine in association among the plurality of processors allows the processor switched to to acquire a corresponding branch target address and readily continue the processing.

Moreover, the switch point determination unit may determine at least one of beginning and end of a callee of the subroutine as the switch point, the at least one of the beginning and end of the callee being the at least a portion of the boundaries of the subroutine.

According to the above configuration, setting at least one of the beginning and end of the callee of the subroutine as the switch point can facilitate the processor switching. For example, managing the return addresses from the subroutine in association among the plurality of processors allows the processor switched to to acquire a corresponding return address and readily continue the processing.

Moreover, the switch point determination unit may determine, as the switch point, at least a portion of the boundaries of the subroutine at which a depth of a level at which the subroutine is called in the source program is shallower than a predetermined threshold.

According to the above configuration, determining the subroutines that are called at shallow levels in the hierarchical structure as the candidates for switch point, rather than determining all the subroutine as the candidates for switch point, can limit the number of switch points. A larger number of switch points increases the number of times the switch decision process is performed, which may end up slowing processing the program. Thus, limiting the number of switch points can reduce the slowdown of processing.

Moreover, the switch point determination unit may determine at least a portion of a branch in the source program as the switch point.

According to the above configuration, determining the branch as the switch point can facilitate the processor switching. For example, managing the branch target addresses in association among the plurality of processors allows the processor switched to to acquire a corresponding branch target address, thereby facilitating the continuation of the processing.

Moreover, the switch point determination unit may exclude a branch to an iterative process in the source program from a candidate for the switch point.

According to the above configuration, the switch decision process can be prevented from being performed at every iteration in the iterative process, thereby reducing the slowdown of processing.

Moreover, the switch point determination unit may determine the switch point so that a time period required for execution of a process included between adjacent switch points is shorter than a predetermined time period.

According to the above configuration, increase of a wait time until the processors are actually switched upon the processor switch request can be prevented.

Moreover, the switch point determination unit may determine a predefined location in the source program as the switch point.

According to the above configuration, the switch point can be designated by the user in generating the source program. Therefore, the processors can be switched therebetween at a spot intended by the user.

Moreover, the program generation unit may generate the switchable programs so that a data structure of a stack of the memory is commonly shared at the switch point among the plural processors.

According to the above configuration, the data structure of the stack is the same at the switch point. Therefore, the processor switched to can utilize the stack as it is.

Moreover, the program generation unit may generate the switchable programs so that a data size and placement of data stored in the stack of the memory is commonly shared at the switch point among the plural processors.

According to the above configuration, the size and placement of the data stored in the stack are the same at the switch point. Therefore, the processor switched to can utilize the stack as it is.

Moreover, the program generation unit may generate the switchable programs so that a data structure in structured data stored in the memory is commonly shared at the switch point among the plural processors.

According to the above configuration, the data structure of the structured data (structure variable) is the same at the switch point as described above. Therefore, the processor switched to can utilize the structured data as it is.

Moreover, the program generation unit may generate the switchable programs so that a data width of data in which the data width is unspecified in the source program is commonly shared at the switch point among the plural processors.

According to the above configuration, the data width of data is commonly shared at the switch point. Therefore, the processor switched to can utilize the data as it is.

Moreover, the program generation unit may generate the switchable programs so that a data structure of data globally defined in the source program is commonly shared at the switch point among the plural processors.

According to the above configuration, the data structure of the global data is the same at the switch point. Therefore, the processor switched to can utilize the global data as it is.

Moreover, the program generation unit may generate the switchable programs so that endian of data stored in the memory is commonly shared at the switch point among the plural processors.

According to the above configuration, the endian of the data is commonly shared at the switch point. Therefore, the processor switched to can utilize the data read out from the memory as it is if the endian of the own processor and the commonly shared endian are the same. Moreover, if the endian of the own processor is different from the commonly shared endian, the processor switched to can utilize the data items read out from the memory by reordering the read data items.

Moreover, the program generation unit may further provide an identifier common to branch target addresses, which indicate a same branch in the source program and are in the switchable programs of the plural processors, and generate an address list in which the identifier and the branch target addresses are associated with each other, and replace a process of storing the branch target addresses in the switchable programs into the memory by a process of storing an identifier corresponding to the branch target addresses into the memory.

According to the above configuration, the branch target addresses of the plurality of processors are managed in association with a common identifier. Therefore, the processor switched to can acquire a branch target address that corresponds to the own processor by acquiring the identifier of the branch target address in a process scheduled to be executed subsequently by the processor switched from. Thus, the processor switched to can continue execution of a task which has been performed by the processor switched from.

Moreover, the program generation unit may generate structured address data in which branch target addresses, which indicate a same branch in the source program and are in the switchable programs of the plural processors, are associated with each other.

According to the above configuration, the structured address data in which the plurality of processors and the respective branch target addresses are managed in association with each other. Therefore, the processor switched to can acquire a branch target address that corresponds to the own processor by acquiring the structured address data which includes a branch target address in a process scheduled to be executed subsequently by the processor switched from. Thus, the processor switched to can continue execution of a task which has been performed by the processor switched from.

Moreover, the plural processors each may include at least one register, and the program generation unit may generate the switchable programs including a process of storing into the memory a value which is stored in the register before the switch point and utilized after the switch point.

According to the above configuration, the values stored in the registers are saved in the memory. Therefore, the processors can be switched therebetween even when there is no guarantee that the values stored in the registers remain across the switch point.

Moreover, the program generation unit may generate the switchable programs so that a data structure of a stack of the memory is commonly shared between a target subroutine, which is a subroutine including the boundary determined as the switch point by the switch point determination unit, and an upper subroutine of the target subroutine.

According to the above configuration, the data is consistent between the target subroutine and its upper subroutine, and the upper subroutine can be executed properly.

Moreover, the insertion unit may insert into the switchable programs a program which calls a system call which is the switch program.

According to the above configuration, the switch program can be executed by the system call.

Moreover, the program generation unit may further generate a switch-dedicated program for each processor, the switch-dedicated program: causing a processor, among the plural processors, corresponding to the switch-dedicated program to determine whether a processor switch is requested; when the processor switch is requested, stopping a switchable program, among the switchable programs, being executed by the processor corresponding to the switch-dedicated program at the switch point, and causing the second processor to execute from the switch point a switchable program, among the switchable programs, corresponding to the second processor; and when the processor switch is not requested, causing continuous execution of the switchable program being executed by the processor corresponding to the switch-dedicated program, and the insertion unit may insert the generated switch-dedicated programs as the switch programs into the switchable programs.

According to the above configuration, the switch program can be executed by the switch-dedicated program in the program.

Moreover, the switch-dedicated program may be configured as a subroutine, and the insertion unit may insert a subroutine call at the switch point.

According to the above configuration, the switch program is configured as a subroutine in the switchable program. Therefore, the switch program can be executed by the subroutine call.

For example, the switch point determination unit may determine as the switch point a call portion of a caller of the subroutine of the source program or a return portion from the subroutine of the source program, and the program generation unit may generate the switchable programs so that the call portion or the return portion determined as the switch point is replaced by the switch-dedicated program.

Moreover, the switch-dedicated program may include processor instructions dedicated to each of the plural processors, and the insertion unit may insert the dedicated processor instructions at the switch point.

According to the above configuration, the switch program is the dedicated processor instructions. Thus, the switch program can be executed by execution of instructions from the processor. Moreover, as compared to the insertion of the program which calls the system call, the use of the dedicated processor instructions can reduce overhead upon the processor switch determination when there is no processor switch request.

For example, the switch point determination unit may determine as the switch point the call portion of a caller of the subroutine of the source program or the return portion from the subroutine of the source program, and the program generation unit may generate the switchable programs so that the call portion or the return portion determined as the switch point is replaced by the dedicated processor instructions.

According to the above configuration, as compared to the insertion of the program which calls the system call, the use of the dedicated processor instructions can reduce overhead upon the processor switch determination when there is no processor switch request.

Moreover, the program generation unit may further set a predetermined section in which the switch point is included as an interrupt-able section in which the processor switch request can be accepted, and set sections other than the interrupt-able section as interrupt-disable sections in which the processor switch request cannot be accepted.

According to the above configuration, providing the interrupt-able section can define a section in which the processors can be switched therebetween, thereby preventing the switch at an unintended position.

Moreover, a processor device according to one aspect of the present invention is a processor device including: plural processors which share a memory and can execute switchable programs corresponding to the plural processors having different instruction sets, a control unit configured to request a switch among the plural processors, wherein the switchable programs are machine programs generated from a same source program so that the data structure of the memory is commonly shared at a switch point, which is a predetermined location in the source program, among the plural processors, each of the switchable programs corresponding to each of the plural processors, and a first processor which is one of the plural processors when the switch is request from the control unit, stops a switchable program, among switchable programs, being executed by and corresponding to the first processor at the switch point, and executes a switch program, among switchable programs, for a second processor which is one of the plural processors to execute from the switch point the switchable program corresponding to the second processor.

According to the above configuration, the data structure of the memory is the same at the switch point. Therefore, executing the switch program can switch the processors therebetween. Switching the processors, herein, is stopping the processor which is executing a program, and causing another processor to execute a program from the stopped point. Thus, according to the processor device according to one aspect of the present invention, the second processor can continue the execution of the task being executed by the first processor.

Moreover, a multiprocessor system according to one aspect of the present invention is a multiprocessor system including: plural processors having different instruction sets and sharing a memory; a control unit configured to request a switch between the plural processors; and a program generation device which generates from a same source program machine programs each corresponding to each of the plural processors, wherein the program generation device includes: a switch point determination unit configured to determine a predetermined location in the source program as a switch point; a program generation unit configured to generate from the source program a switchable program which is the machine program for each processor so that the data structure of the memory is commonly shared at the switch point among the plural processors; and an insertion unit configured to insert into the switchable program a switch program for stopping at the switch point a switchable program, among the switchable programs, being executed by and corresponding to a first processor which is one of the plural processors, and causing a second processor which is one of the plural processors to execute from the switch point a switchable program, among the switchable programs, corresponding to the second processor, and the first processor executes the switch program corresponding to the first processor when the switch is requested from the control unit.

According to the above configuration, the data structure of the memory is the same at the switch point. Therefore, executing the switch program can switch the processors therebetween. Switching the processors, herein, is stopping the processor which is executing a program, and causing another processor to execute a program from the stopped point. Thus, according to the multiprocessor system of one aspect of the present invention, the second processor can continue the execution of the task being executed by the first processor.

Moreover, a switchable program according to one aspect of the present invention is includes a machine program generated from a source program and executed by a first processor which is one of plural processors having different instruction sets and sharing a memory, the machine programs each including: a function of performing a process so that a data structure of the memory is commonly shared at a switch point among the plural processors, the switch point being a predetermined location in the source program; and a function of stopping the machine program at the switch point and executing a switch program for causing a second processor which is one of the plural processors to execute, from the switch point, a machine program generated from the source program and corresponding to the second processor.

It should be noted that the present invention can be implemented not only in the program generation device or the processor device, but also as a method having processing units, as steps, included in the program generation device or the processor device. The present invention also can be implemented in a program for causing a computer to execute such steps. Furthermore, the present invention may be implemented in a recording medium such as a computer-readable CD-ROM (Compact Disc-Read Only Memory) having stored therein the program, and information, data, or signals indicating the program. In addition, such program, information, data, and signals may be distributed via a communication network such as the Internet.

### Advantageous Effects

According to the present invention, the migration of a process between processors is allowed even during execution of a task, and changes in statuses of system and use case can be accommodated.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a block diagram of an example configuration of a multiprocessor system according to an embodiment of the present invention.

FIG. 2 is a block diagram of an example configuration of a program generation device (compiler) according to the embodiment of the present invention.

FIG. 3A is a diagram showing an example of data structures of a stack area, a global data area, and an output data area, and a register configuration in a program dedicated to a processor A according to the embodiment of the present invention.

FIG. 3B is a diagram showing an example of data structures of the stack area, the global data area, and the output data area, and the register configuration in a program dedicated to a processor B according to the embodiment of the present invention.

FIG. 3C is a diagram showing an example of data structures of the stack area, the global data area, and the output data area, and the register configuration in a switchable program according to the embodiment of the present invention.

FIG. 4A is a diagram showing an example of a program address list according to the embodiment of the present invention.

FIG. 4B is a diagram showing an example of a program address list according to the embodiment of the present invention.

FIG. 5A is a flowchart illustrating an example of a typical program of a caller of a subroutine according to the embodiment of the present invention.

FIG. 5B is a flowchart illustrating an example of the switchable program of the caller of the subroutine according to the embodiment of the present invention.

FIG. 5C is a flowchart illustrating an example of the switchable program of the caller of the subroutine according to the embodiment of the present invention.

FIG. 6A is a flowchart illustrating an example of a typical program for a return process from the subroutine according to the embodiment of the present invention.

FIG. 6B is a flowchart illustrating an example of a switchable program for the return process from the subroutine according to the embodiment of the present invention.

FIG. 6C is a flowchart illustrating an example of a switchable program for the return process from the subroutine according to the embodiment of the present invention.

FIG. 7A is a flowchart illustrating an example operation of a processor switched from in a processor switching process according to the embodiment of the present invention.

FIG. 7B is a flowchart illustrating an example operation of a processor switched to in the processor switching process according to the embodiment of the present invention.

FIG. 8A is a flowchart illustrating an example operation of the program generation device according to the embodiment of the present invention.

FIG. 8B is a flowchart illustrating an example of operation of the program generation device according to the embodiment of the present invention.

FIG. 9 is a sequence diagram showing an example operation of the multiprocessor system according to the embodiment of the present invention.

FIG. 10 is a diagram showing an example of a source program according to the embodiment of the present invention.

FIG. 11 is a diagram showing an example of a typical machine program and a processor-switchable machine program according to the embodiment of the present invention.

FIG. 12 is a diagram showing an example of stack structures according to the embodiment of the present invention.

FIG. 13 is a diagram illustrating an example in which a boundary of a basic block is determined as a switch point in the embodiment according to the present invention.

FIG. 14A is a diagram illustrating an example in which a call portion and a return portion of the caller of the subroutine are determined as switch points in the embodiment according to the present invention.

FIG. 14B is a diagram illustrating an example in which the beginning and end of the callee of the subroutine are determined as switch points in the embodiment according to the present invention.

FIG. 14C is a diagram illustrating an example in which a boundary of the subroutine is determined as a switch point in the embodiment according to the present invention.

FIG. 15 is a diagram illustrating an example in which a switch point is determined based on the depth of a level of a subroutine according to a variation of the embodiment of the present invention.

FIG. 16 is a diagram illustrating another example in which a switch point is determined based on the depth of a level of a subroutine according to the variation of the embodiment of the present invention.

FIG. 17A is a diagram showing an example of a source program for illustrating an example in which a switch point is determined based on a branch point according to the variation of the embodiment of the present invention.

FIG. 17B is a diagram showing an example of a machine program for illustrating an example in which the switch point is determined based on the branch point according to the variation of the embodiment of the present invention.

FIG. 18 is a diagram illustrating an example in which switch points are determined at predetermined intervals according to the variation of the embodiment of the present invention.

FIG. 19 is a diagram illustrating an example in which a switch point is determined by user designation according to the variation of the embodiment of the present invention.

FIG. 20 is a flowchart illustrating an example of a switch request determination process according to the variation of the embodiment of the present invention.

FIG. 21A is a diagram showing an example of structured data according to the variation of the embodiment of the present invention.

FIG. 21B is a diagram showing an example of a data structure of the structured data according to the variation of the embodiment of the present invention.

FIG. 22A is a diagram showing an example of data in which a data width according to the variation of the embodiment of the present invention is unspecified.

FIG. 22B is a diagram showing an example of a data structure of the data in which the data width according to the variation of the embodiment of the present invention is unspecified.

FIG. 23A is a diagram showing an example of data according to the embodiment of the present invention.

FIG. 23B is a diagram illustrating endian of the data commonly shared among a plurality of processors according to the embodiment of the present invention.

FIG. 24 is a diagram illustrating an example of a process in which the data structure of a memory is commonly shared according to the level of a subroutine according to the variation of the embodiment of the present invention.

FIG. 25A is a diagram showing an example of structured address data according to the variation of the embodiment of the present invention.

FIG. 25B is a flowchart illustrating an example of a switchable program of a caller of a subroutine according to the variation of the embodiment of the present invention.

FIG. 25C is a flowchart illustrating an example of a switchable program of a caller of a subroutine according to the variation of the embodiment of the present invention.

FIG. 25D is a flowchart illustrating an example of the switchable program for a return process from a subroutine according to the variation of the embodiment of the present invention.

FIG. 26A is a flowchart illustrating an example of the switchable program of a caller of the subroutine according to the variation of the embodiment of the present invention.

FIG. 26B is a flowchart illustrating an example of the switchable program of the caller of the subroutine according to the variation of the embodiment of the present invention.

FIG. 26C is a flowchart illustrating an example of specific subroutine call instructions according to the variation of the embodiment of the present invention.

FIG. 27A is a diagram showing an example of interrupt-able sections and interrupt-disable sections according to the variation of the embodiment of the present invention.

FIG. 27B is a diagram showing an example of the interrupt-disable section according to the variation of the embodiment of the present invention.

### DESCRIPTION OF EMBODIMENT

Hereinafter, a program generation device (compiler), a processor device, and a multiprocessor system according to an embodiment of the present invention will be described in detail, with accompanying drawings. It should be noted that embodiments described below are each merely preferred illustration of the present invention. Values, components, disposition or a form of connection between the components, steps, and the order of the steps are merely illustrative, and are not intended to limit the present invention. The present invention is limited only by the scope of the appended claims. Thus, among components of the below embodiments, components not set forth in the independent claims indicating the top level concept of the present invention are not necessary to achieve the present invention but will be described as components for preferable embodiments.

The program generation device according to the embodiment of the present invention generates, from the same source program, machine programs corresponding to the plurality of processors having different instruction sets and sharing a memory. The program generation device according to the embodiment of the present invention includes: the switch point determination unit which determines a predetermined location in the source program as the switch point; the program generation unit which generates, for each processor, the switchable program, which is the machine program, from the source program so that the data structure of the memory is commonly shared at the switch point among the plurality of processors; and the insertion unit which inserts the switch program into the switchable program.

Herein, the switch program is a program for stopping a switchable program that corresponds to the first processor and is being executed by the first processor at the switch point, and causing the second processor to execute, from the switch point, a switchable program that corresponds to the second processor.

Moreover, the switchable programs are machine programs which are generated from the source program and executed by plural processors having different instruction sets and sharing a memory. The switchable programs each include: a function of performing a process so that a data structure of the memory is commonly shared at a switch point among the plural processors, the switch point being a predetermined location in the source program; and a function of executing a switch program for stopping the switchable program at the switch point and causing another processor which is one of the plural processors to execute, from the switch point, a machine program generated from the source program and corresponding to the other processor.

In short, the program generation device (compiler) according to the embodiment of the present invention is a cross compiler which translates a source program written in a high level language such as C language into respective machine programs that correspond to and can be executed by the plurality of processors having different instruction sets. This allows a process to be consistent even if the process is suspended at a specific position in halfway through the process and causes another processor to resume the process.

Moreover, the processor device according to the embodiment of the present invention includes a plurality of processors and a control unit which controls a switch between the plurality of processors. In short, a first processor which is one of the plurality of processors executes the above switch program when requested from the control unit to switch.

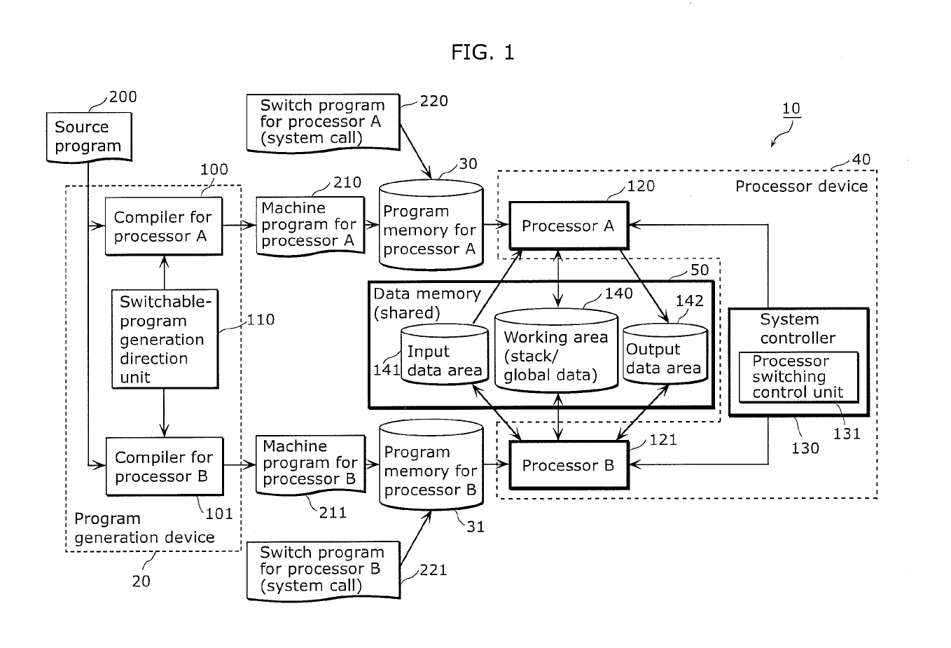

FIG. 1 is a block diagram of an example configuration of a multiprocessor system 10 according to the embodiment of the present invention which achieves cross compiler environment. As shown in FIG. 1, the multiprocessor system includes a program generation device 20, a program memory 30 for a processor A, a program memory 31 for a processor B, a processor device 40, and a data memory 50.

The program generation device 20 generates, from the same source program 200, machine programs corresponding to the plurality of processors. The source program 200 is a source program (source code) written in a high level language. Examples of the high level language include C language, Java (registered trademark), Perl, and FORTRAN. The machine program is written in a programming language understood by each processor, examples of which include a collection of binary electric signals.

As shown in FIG. 1, the program generation device 20 includes a compiler 100 for the processor A, a compiler 101 for the processor B, and a switchable-program generation direction unit 110.

The compiler 100 for processor A converts the source program 200 to generate a machine program that corresponds to a processor A120 included in the processor device 40. The compiler 100 for processor A receives direction from the switchable-program generation direction unit 110 and switches between methods of generating the machine program.

Specifically, when received the direction to generate a switchable program from the switchable-program generation direction unit 110, the compiler 100 for processor A generates a switchable program A that corresponds to the processor A120 so that the data structure of the data memory 50 is commonly shared at a switch point, which is a predetermined location in the source program 200, among the plurality of processors. In other words, the compiler 100 for processor A converts the source program 200 according to common rules among the plurality of processors, to generate the switchable program A. The generated switchable program A is stored as a machine program 210 for processor A in the program memory 30 for processor A.

Moreover, the compiler 100 for processor A, when does not receive the direction to generate the switchable program from the switchable-program generation direction unit 110, converts the source program 200 according to rules specific to the processor A120, to generate a dedicated machine program A that corresponds to the processor A120. The generated dedicated machine program A is stored as a machine program 210 for processor A in the program memory 30 for processor A.

The compiler 101 for processor B converts the source program 200 to generate a machine program that corresponds to a processor B121 included in the processor device 40. The compiler 101 for processor B receives the direction from the switchable-program generation direction unit 110 and switches between methods of generating the machine program.

Specifically, when received the direction to generate the switchable program from the switchable-program generation direction unit 110, the compiler 101 for processor B generates a switchable program B that corresponds to the processor B121 so that the data structure of the data memory 50 is commonly shared at the switch point among the plurality of processors. In other words, the compiler 101 for processor B converts the source program 200 according to the common rules among the plurality of processors, to generate the switchable program B. The generated switchable program B is stored as a machine program 211 for a processor B in the program memory 31 for processor B.

Moreover, the compiler 101 for processor B, when does not receive the direction to generate the switchable program from the switchable-program generation direction unit 110, converts the source program 200 according to rules specific to the processor B121, to generate a dedicated machine program B that corresponds to the processor B121. The generated dedicated machine program B is stored as a machine program 211 for processor B in the program memory 31 for processor B.

The switchable-program generation direction unit 110 is by way of example of a direction unit which directs the compiler 100 for processor A and the compiler 101 for processor B to generate the respective switchable programs. Specifically, the switchable-program generation direction unit 110 determines whether to direct the generation of the switchable programs, according to the source program 200.

For example, when the source program 200 is not a program that can be executed only by a specific processor, the switchable-program generation direction unit 110 directs the generation of the switchable programs. In other words, when the source program 200 is a program that can be executed by any processor, the switchable-program generation direction unit 110 directs the generation of the switchable programs.

It should be noted that by including the switchable-program generation direction unit 110, the program generation device 20 can selectively generate the switchable programs. For example, when the source program 200 can be executed only by a specific processor, it is not necessary to generate the switchable programs. In such a case, throughput required for program generation can be reduced by not directing the generation of the switchable programs.

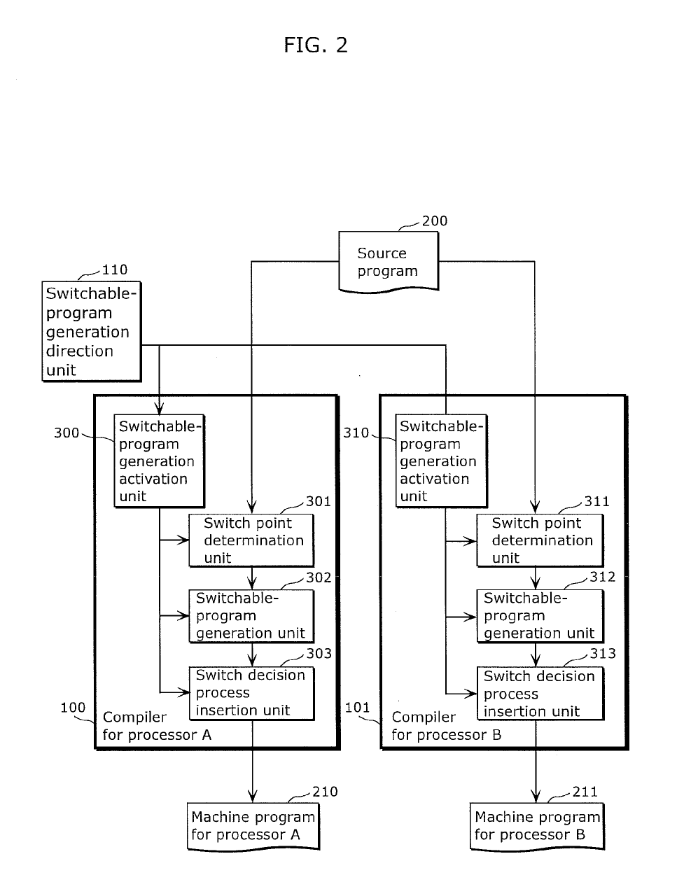

The detailed configuration of the program generation device 20 will be described below, with reference to FIG. 2.

The program memory 30 for processor A is a memory for storing the machine program 210 for processor A that is generated by the compiler 100 for processor A. Specifically, a switchable program A or the dedicated machine program A is stored in the program memory 30 for processor A. Moreover, the program memory 30 for processor A stores a switch program 220 for processor A (hereinafter, system call).

The program memory 31 for processor B is a memory for storing the machine program 211 for processor B that is generated by the compiler 101 for processor B. Specifically, the switchable program B or the dedicated machine program B is stored in the program memory 31 for processor B. Moreover, the program memory 31 for processor B stores a switch program 221 for processor B (hereinafter, system call).

The switch program 220 for processor A and the switch program 221 for processor B are by way of example of the switch programs according to the present invention, and are executed by an operation system (OS). The switch program is a program for stopping at the switch point a switchable program that corresponds to the first processor and is being executed by the first processor, and causing the second processor to execute from the switch point a switchable program that corresponds to the second processor.

It should be noted that the first processor and the second processor are each one of the plural processors included in the processor device 40. The first processor is a processor switched from, and the second processor is different from the first processor and is a processor switched to.

Specifically, the switch program is a program for causing each processor to detect a processor switch request, suspend a process being performed by the first processor at the switch point, and resume the process in the second processor from the switch point. For example, when the processor is switched from the processor A120 to the processor B121, the switch program 220 for processor A is executed by the OS, and when the processor is switched from the processor B121 to the processor A120, the switch program 221 for processor B is executed by the OS.

The processor device 40 includes the plurality of processors having different instruction sets and sharing a memory therebetween, and executes, using a corresponding processor from among the plurality of processors, at least one of the plural machine programs generated from the same source program. As shown in FIG. 1, the processor device according to the present embodiment includes the processor A120, the processor B121, and a system controller 130.

The processor A120 is one of the plural processors included in the processor device 40 and has an instruction set different from an instruction set of the processor B121. The processor A120 shares the data memory 50 with the processor B121. The processor A120 includes at least one register, and executes the machine program 210 for processor A stored in the program memory 30 for processor A, using the register and the data memory 50.

The processor B121 is one of the plural processors included in the processor device 40 and has the instruction set different from the instruction set of the processor A120. The processor B121 shares the data memory 50 with the processor A120. The processor B121 includes at least one register, and executes the machine program 211 for processor B stored in the program memory 31 for processor B, using the register and the data memory 50.

The system controller 130 controls the plurality of processors included in the processor device 40. As shown in FIG. 1, the system controller 130 includes a processor switching control unit 131.

The processor switching control unit 131 requests a switch among a plurality of processors. In other words, the processor switching control unit 131 controls an entire sequence for processor switching. For example, the processor switching control unit 131 detects changes in a state of the multiprocessor system 10, and determines if the processor is to be switched.

Specifically, the processor switching control unit 131 determines, from a standpoint of power saving, whether it is necessary to switch the processor, and when determined that it is necessary to switch the processor, requests the processor device 40 to switch the processor. For example, when switching the processor enhances power efficiency, the processor switching control unit 131 determines that it is necessary to switch the processor. Alternatively, the processor switching control unit 131 may determine that it is necessary to switch the processor upon the need to cause the processor executing a current program to preferentially execute another program.

The data memory 50 is a memory which is shared among the plurality of processors included in the processor device 40. For example, as shown in FIG. 1, the data memory 50 includes a working area 140, an input data area 141, and an output data area 142.

The working area 140 includes, as described below, a stack area and a global data area. The stack area is a memory area which holds data by using Last In, First Out (LIFO) method. The global data area is a memory area which holds, during execution of a program, data referred to across subroutines, that is, data (global data) globally defined in a source program.

The input data area 141 is a memory area which holds input data. The output data area 142 is a memory area which holds output data.

While in the present embodiment, the processor device 40 includes two processors (the processor A120 and the processor B121), the processor device 40 may include three or more processors. Moreover, the processor device 40 may include processors which have a common instruction set. In other words, the processor A120 and the processor B121 may have an instruction set of the same type and execute the same machine program.

Subsequently, the configuration of the program generation device 20 according to the embodiment of the present invention will be described in detail. FIG. 2 is a block diagram of an example configuration of the program generation device 20 (compiler) according to the embodiment of the present invention in detail.

As shown in FIG. 2, the compiler 100 for processor A includes a switchable-program generation activation unit 300, a switch point determination unit 301, a switchable-program generation unit 302, and a switch decision process insertion unit 303. The compiler 101 for processor B includes a switchable-program generation activation unit 310, a switch point determination unit 311, a switchable-program generation unit 312, and a switch decision process insertion unit 313.

When received the direction to generate the switchable program from the switchable-program generation direction unit 110, the switchable-program generation activation unit 300 controls a machine program generation mode of the compiler 100 for processor A. The machine program generation mode includes a mode to generate the switchable program A and a mode to generate the dedicated machine program A.

Specifically, when received the direction for generation of the switchable program, the switchable-program generation activation unit 300 selects the mode to generate the switchable program A. The switchable-program generation activation unit 300, when does not receive the direction for the generation of the switchable program, selects the mode to generate the dedicated machine program A. The selection result is outputted to the switch point determination unit 301, the switchable-program generation unit 302, and the switch decision process insertion unit 303.

When the mode to generate the switchable program A is selected, the switch point determination unit 301 determines a predetermined location in the source program 200 as a processor switching point (hereinafter, also described simply as a switch point). In other words, when the switchable-program generation direction unit 110 directs the generation of the switchable programs, the switch point determination unit 301 determines a switch point.

When the switchable-program generation direction unit 110 does not direct the generation of the switchable programs, the switch point determination unit 301 does not determine a switch point. Specifically, in this case, the switch point determination unit 301 is disabled by the switchable-program generation activation unit 300. In other words, the switch point determination unit 301 determines a switch point when directed to generate the switchable program.

For example, the switch point determination unit 301 determines as a switch point at least a portion of boundaries of a basic block of the source program. The basic block is, for example, a subroutine of the source program. In this case, the switch point determination unit 301 determines at least a portion of boundaries of the subroutine as a switch point. Specifically, the switch point determination unit 301 determines as a switch point a call portion of the caller of the subroutine which is a boundary of the subroutine. Alternatively, the switch point determination unit 301 may determine at least either one of the beginning and the end of the callee of the subroutine, which is a boundary of the subroutine, as a switch point.

The switchable-program generation unit 302 generates from the source program 200 the switchable program A which is a machine program corresponding to the processor A120, so that data structure of the data memory 50 at the switch point is commonly shared among the plurality of processors. In other words, the switchable-program generation unit 302 controls generation of a program so that a state of data memory is kept consistent when a machine program supported by the own processor is executed at a switch point and when a machine program supported by another processor is executed at the same switch point.

For example, the switchable-program generation unit 302 generates the switchable program A so that the data structure of the stack area of the data memory 50 is commonly shared among the plurality of processors. Specifically, the switchable-program generation unit 302 generates the switchable program A so that data size and placement of data stored in the stack area of the data memory 50 are commonly shared among the plurality of processors. Here, the switchable-program generation unit 302 generates the switchable program A so that the arguments and the working data to be utilized in the subroutine is stored into the stack area of the data memory 50 rather than into registers included in the processor.

Furthermore, the switchable-program generation unit 302 generates the switchable program A so that the data structure of the global data area of the data memory 50 is commonly shared among the plurality of processors. Moreover, the switchable-program generation unit 302 generates the switchable program A so that data size and placement of data in an area reserved in the data memory 50 for storing arguments, the working data, the global data, and the like are commonly shared among the plurality of processors.

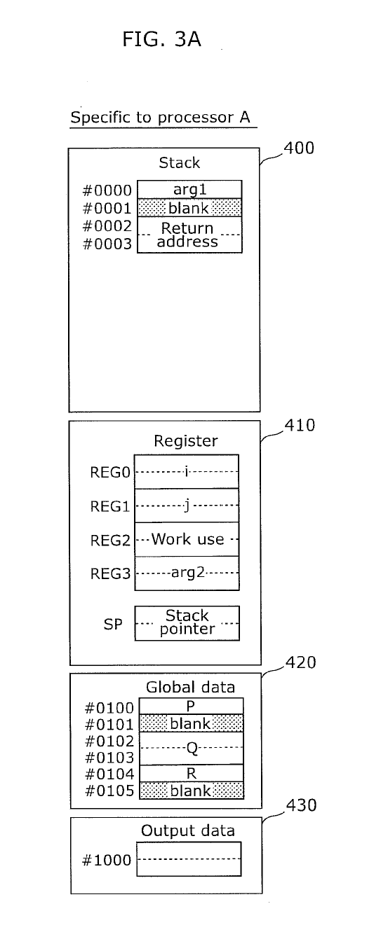

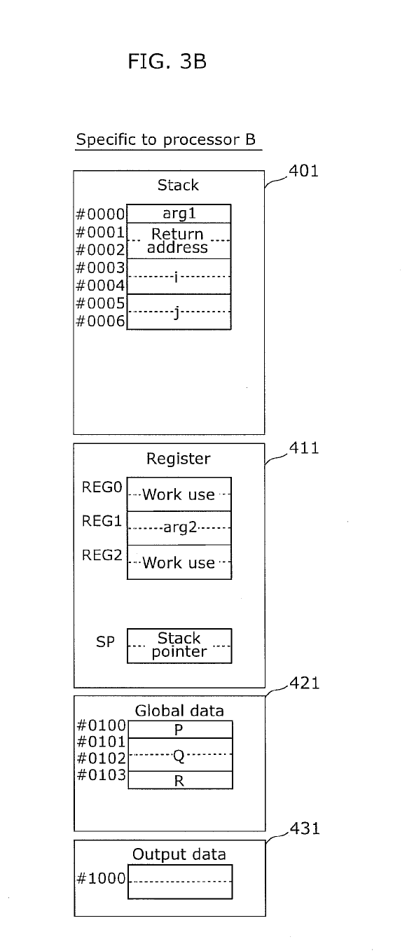

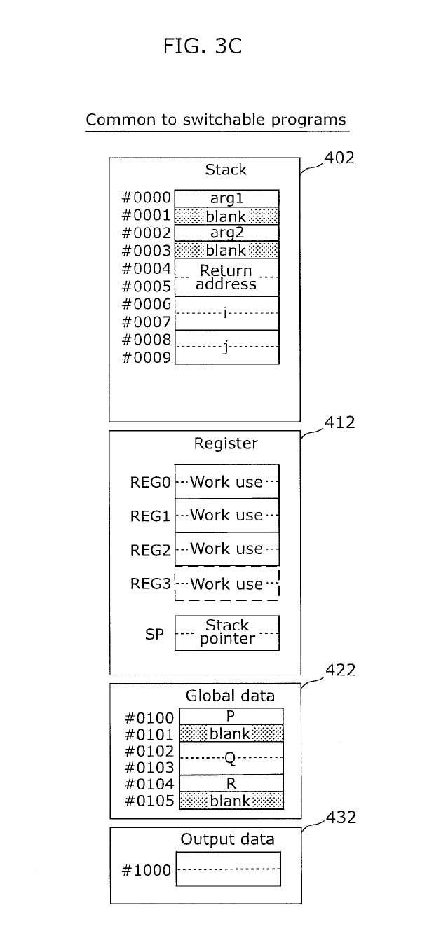

Specifically, the switchable-program generation unit 302 generates the switchable program A, according to the common rules among the plurality of processors, to achieve commonly sharing the data size and the placement of data among the plurality of processors. The common rules satisfy, for example, constrains of all the plurality of processors. More specific example will be described below, with reference to FIGS. 3A, 3B, and 3C.

When the switchable-program generation direction unit 110 does not direct the generation of the switchable programs, the switchable-program generation unit 302 does not generate the switchable program. In other words, in this case, the switchable-program generation unit 302 generates from the source program 200 a program (the dedicated machine program A) that can be executed only by the processor A120 of the plurality of processors. In other words, the switch point determination unit 301 generates the switchable program only when directed to generate the switchable program.

The switch decision process insertion unit 303 inserts the switch program 220 for processor A into the switchable program A. Specifically, the switch decision process insertion unit 303 inserts into the switchable program A a program which is a system call which performs the switching process, and calls the switch program 220 for processor A.

When the switchable-program generation direction unit 110 does not direct the generation of the switchable programs, the switch decision process insertion unit 303 does not insert the switch program. In other words, in this case, the switch decision process insertion unit 303 is disabled by the switchable-program generation activation unit 300. In other words, the switch decision process insertion unit 303 inserts the switch program when the generation of the switchable program is directed.

It should be noted that the processing components included in the compiler 101 for processor B are the same as the processing components included in the compiler 100 for processor A. In other words, the switchable-program generation activation unit 310, the switch point determination unit 311, the switchable-program generation unit 312, and the switch decision process insertion unit 313 correspond to the above described switchable-program generation activation unit 300, switch point determination unit 301, switchable-program generation unit 302, and switch decision process insertion unit 303, respectively. Thus, the description will be omitted herein.

Hereinafter, in the present embodiment, an example will be described where a boundary of a subroutine is used by way of example of the processor switching point.

For example, in the present embodiment, it is assumed that a time at which a subroutine call is made and a point of return from the subroutine are the processor switching points. This is because the state of the stack in the subroutine is clear in the source program, and this has advantageous effects of facilitating that the data size and the placement of data are commonly shared among the plurality of processors.

FIGS. 3A to 3C are diagrams each showing an example of the data structures of the stack area, the global data area, and the output data area, and a register configuration according to the embodiment of the present invention.

Specifically, FIG. 3A is a diagram showing an example of memory resources used by the processor A120 when executing the machine program dedicated to the processor A which corresponds to a predetermined subroutine. FIG. 3B is a diagram showing an example of memory resources used by the processor B121 when executing the machine program dedicated to the processor B which corresponds to a predetermined subroutine. FIG. 3C is a diagram showing an example of memory resources used by each processor when executing the switchable program which corresponds to a predetermined subroutine.

As shown in FIGS. 3A, 3B, and 3C, the memory resources include the stack area 400, 401, and 402, a register 410, 411, and 412, a global data area 420, 421, and 422, and an output data area 430, 431, and 432, respectively. The stack area 400, 401, and 402, the global data area 420, 421, and 422, and the output data area 430, 431, and 432, are memory areas of the data memory 50.

The register 410 is one of the registers included in the processor A120 that is utilized when the processor A120 executes the predetermined subroutine according to the machine program dedicated to the processor A. The register 411 is one of the registers included in the processor B121 that is utilized when the processor B121 executes the predetermined subroutine according to the machine program dedicated to the processor B. The register 412 is utilized when the processor A120 or the processor B121 executes the predetermined subroutine according to the switchable program.

In general, a compiler generates a machine program which uses the stack and the register differently depending on the number of hardware registers included in a corresponding processor and restrictions to access a memory.

For example, it is assumed that an argument arg1 of the subroutine is defined as 1-byte data in the source program. Here, in the example shown in FIG. 3A, data access of the processor A120 is limited to in 2-byte unit, and thus a 2-byte area (#0000 and #0001) in the stack area 400 is reserved for arg1. In contrast, the processor B121 can perform 1-byte access, and thus, in view of memory efficiency, reserves merely 1-byte area (#0000) in the stack area 400 for arg1.

Herein, if the process is suspended at the beginning or in halfway through the subroutine and another processor utilizes the stack memory as it is, the other processor cannot continue the processing normally because the data placement is not suited to the other processor. For example, when the processor is switched from the processor B121 to the processor A120, the processor A120 cannot access “Return address” of the stack area 401. Thus, there is a problem that the operation cannot be continued normally.

In contrast, as shown in FIG. 3C, in the switchable program according to the embodiment of the present invention, the 2-byte area (#0000 and #0001) of the stack area 402 is reserved for the argument arg1 due to the conditions that the processor A120 is allowed to access data only in 2-byte unit. In other words, the switchable-program generation units 302 and 312 determine the data structure of the stack area 402 so that an area that satisfies the data sizes in the unit of access for both the processors is reserved for one data item. This allows both the processor B121 which can access data in 1-byte unit and the processor A120 which can access data in 2-byte unit to properly read/write data to/from the stack area 402.

Specifically, the switchable-program generation units 302 and 312 determine the data structure of the stack area 402 so that the conditions to access the data memory 50 for both the processor A120 and the processor B121 is satisfied. Then, the switchable-program generation units 302 and 312 each generate a switchable program corresponding to a corresponding processor so that the determined data structure is configured at the switch point.

In other words, the switchable-program generation unit 302 sets rules for the stack structure common to the plurality of processors to overcome the problem that the state of the stack area is not commonly shared among the plurality of processors. Then, the switchable-program generation unit 302 generates the processor-switchable program, according to the common rules, thereby guaranteeing the consistency in content of the stack area among the plurality of processors. For example, for a 1-byte data such as the input argument arg1, 2 bytes of a memory area is always reserved considering that the processor A120 cannot access the stack area in 1-byte unit.

An area holding the working data items i and j which are used during execution of the predetermined subroutine is the register 410 (REG0 and REG1) in the machine program dedicated to the processor A as shown in FIG. 3A. In the machine program dedicated to the processor B, on the other hand, the working data items i and j are held in the stack area 401 (#0003 to #0006) as shown in FIG. 3B.

This is due to a difference between the number of registers (four in the example of FIG. 3A) included in the processor A120 and the number of registers (three in the example of FIG. 3B) included in the processor B121. In other words, this is due to a fact that the processor A120 includes some spare registers, and to improve performance, reserves registers specifically for the working data items i and j. As a result, the working data items i and j are not held in the stack area 401 when the processor is switched from the processor A120 to the processor B121 in halfway through the subroutine being executed by the processor A120. Thus, the processor B121 cannot continue the processing.

In contrast, as shown in FIG. 3C, in the switchable program according to the embodiment of the present invention, the register 412 is utilized entirely as working areas. Specifically, considering the difference in the number of registers for each processor and the inheritance of the state of the processor upon switching between the processors, the input arguments arg1 and arg2 are stored into the stack area 402 (#0000 to #0003) rather than into the hardware registers. The working data items i and j are held in the stack area 402 (#0006 to #0009) as well. Furthermore, for data in the subroutine that needs to take over the address of the subroutine to a lower subroutine, an area is reserved always in the same placement in the stack area 402.

Herein, to reserve an amount of data that can be processed, irrespective of the register configurations of the plurality of processors, the stack area 402 which can store all data defined in the source program 200 is reserved. In this case, the working areas of the stack need not be necessarily used for the same purpose and may be the same in the reserved size.

Similarly to the stack area 402, the global data area 422 also can be directly taken over to another processor by determining, using common rules, the order and the placement of data items in the global data area 422 so as not to be processor-dependent. For example, it is assumed that global data items P and R are each defined by 1 byte in a program source code. In this case, as shown in FIG. 3A, a 2-byte area (such as #0100 and #0101) is reserved in the machine program dedicated to the processor A because the processor A cannot access the data area in 1-byte unit while a 1-byte area (such as #0100) is reserved in the machine program dedicated to the processor B.

In contrast, in the processor-switchable programs, all the global data area is of 2 bytes as shown in FIG. 3C. In other words, a 2-byte area is reserved in the global data area of the data memory 50 for each of the global data items P, Q, and R.

2-byte area is reserved for the output data area as well. Moreover, the use of the registers used in the subroutine does not affect the consistency of the data memory 50 at the beginning and end of the subroutine, and thus may be optimized differently according to the characteristics of individual processors.

Accordingly, the states of the beginning and end of the subroutine which are required for switching between the processors can be taken over using the data memory 50. Furthermore, since the data memory does not depend on the difference in the number of registers for each processor, the processors can be switched therebetween.

Specifically, the data structure of the stack, that is, the size and placement of the data stored in the stack are the same at the switch point. Therefore, the processor switched to can utilize the stack as it is. Moreover, the data structure of the global data is the same at the switch point. Therefore, the processor switched to can utilize the global data as it is. Moreover, the values stored in the registers are saved in the memory. Therefore, the processors can be switched therebetween even when there is no guarantee that the values stored in the registers remain across the switch point.

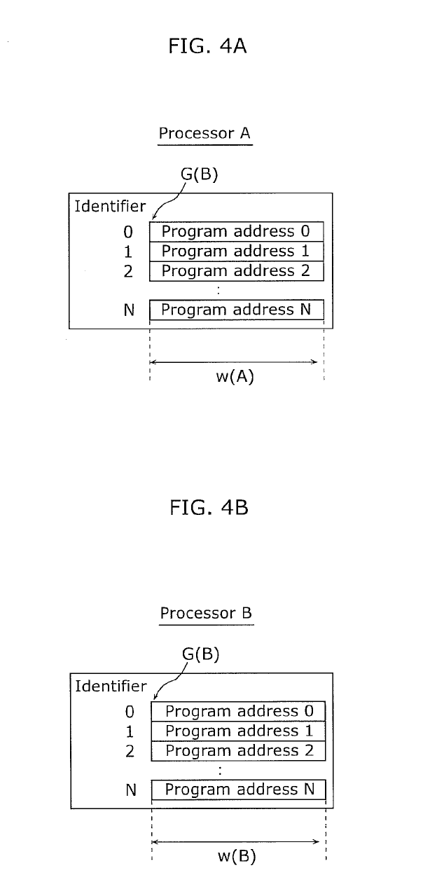

FIGS. 4A and 4B are diagrams each showing an example of a program address list according to the embodiment of the present invention. FIG. 4A shows a program address list which is referred to by the processor A120, and FIG. 4B shows a program address list which is referred to by the processor B121.

The switchable-program generation units 302 and 312 provide a common identifier (ID) to branch target addresses, which are in the switchable programs of the plurality of processors and indicate the same branch in the source program 200, and generate program address lists in which the identifier is associated with the branch target addresses. The generated program address lists are stored in, for example, the data memory 50, or an internal memory included in each processor.

Specifically, as shown in FIGS. 4A and 4B, branch target program addresses used in the machine programs of respective processors are managed in the program address lists. The branch target program address is, specifically, an address indicative of the branch target of the subroutine, a return point (a point of return) from the subroutine, and the like.

As mentioned above, the program addresses cannot be commonly shared between the compilers of the processors which have different instruction sets. Therefore, in the present embodiment, the branch target addresses are managed in lists throughout the entire program, and when storing a program address during the process, a branch target address identifier common to the processors, rather than the address itself, is stored in the data memory 50. Then, at branching, each processor reads out the branch target address identifier from the data memory 50, and based on the read branch target address identifier, refers to the program address list of a corresponding processor, thereby deriving the program address.

The program addresses are stored in the program lists shown in FIGS. 4A and 4B in association with the identifiers. The program addresses are the branch target program addresses corresponding to the machine programs of respective processors. By the processors commonly sharing a corresponding branch target identifier therebetween, the data memory in which the program addresses is stored can also be used as it is by another processor.

Herein, an example of the list structure of the program address lists, and a method for deriving program addresses from the program address lists will be described.

For example, the program address lists which include only program addresses as a data array are stored in the data memory 50. The identifier is represented by a number starting from 0, indicating a location of a corresponding program address in the data array. For example, assuming that data size for one program address is w(s) bytes (where is a processor number) and the starting address of the data array is G(s), a program address corresponding to the branch target the identifier of which is N is stored at an address represented by G(s)+(N×w(s)) in the data memory. By reading out an address as such, each processor can obtain a desired program address.

In the present embodiment, since the switch point determination units 301 and 311 determine the boundary of the subroutine as the switch point, the branch target address corresponds to an address indicative of the switch point. In other words, the same identifier is provided to a program address that indicates the same switch point.

Thus, when the processor is switched from the processor A120 to the processor B121 at a certain switch point, the processor B121 switched to refers to the program address list of the processor B121 shown in FIG. 4B to acquire, from the data memory 50, a program address corresponding to the same identifier as the identifier indicative of the switch point (the branch target address) of the program which has been executed by the processor A120 switched from.

Thus, the branch target addresses of the plurality of processors are managed in association with a common identifier. Therefore, the processor switched to can acquire a branch target address that corresponds to the own processor by acquiring the identifier of the branch target address in a process scheduled to be executed subsequently by the processor switched from. Thus, the processor switched to can continue execution of a task which has been performed by the processor switched from.

Herein, the switchable programs generated by the program generation device 20 according to the embodiment of the present invention will be described. In other words, the switchable programs are executed by the processor device 40. Thus, herein, operation of the processor device 40 according to the embodiment of the present invention will be described.

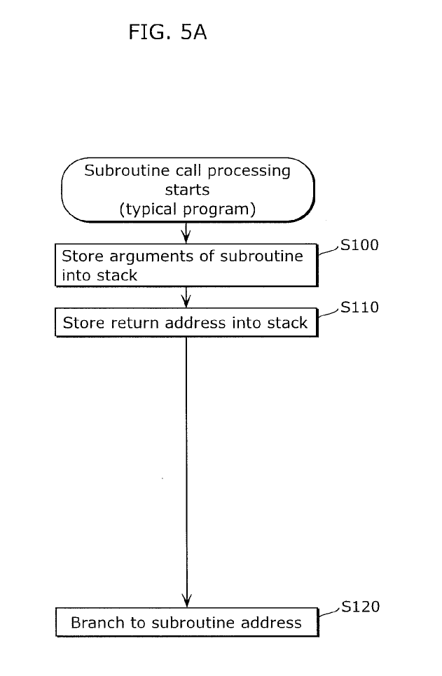

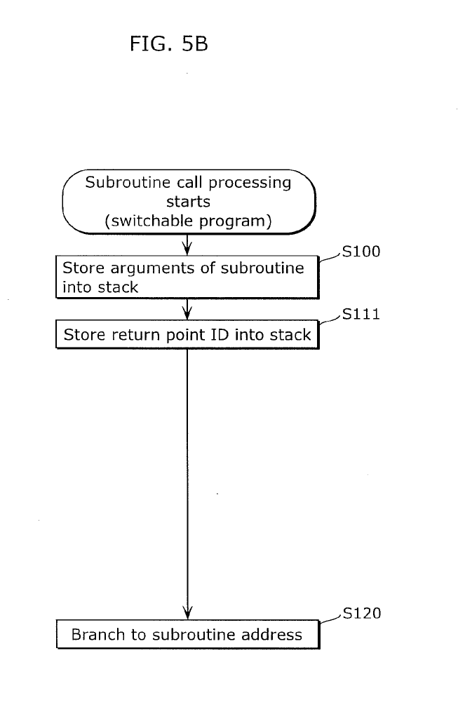

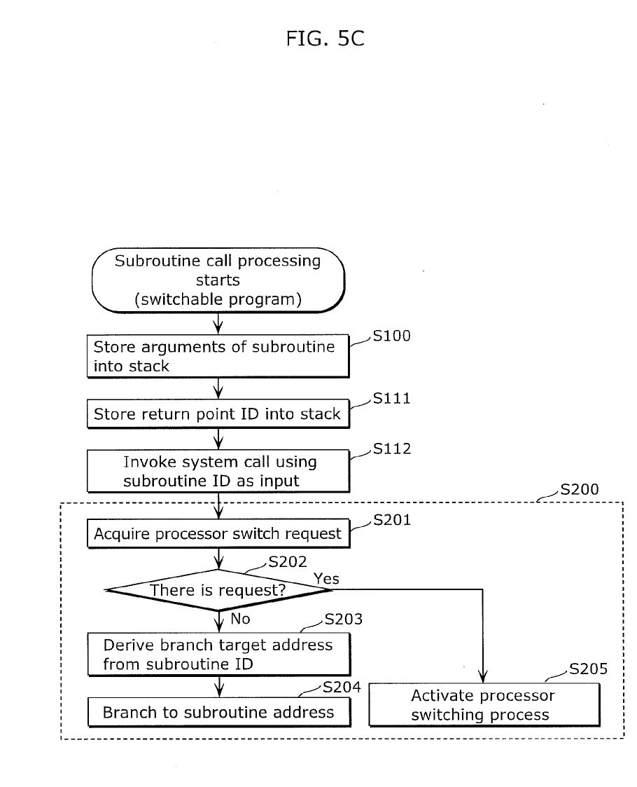

FIGS. 5A, 5B, and 5C are diagrams each showing a program of the caller of the subroutine according to the embodiment of the present invention. First, referring to FIG. 5A, a typical program of a caller of a subroutine, that is, a subroutine call process (subroutine call) will be described.

By executing the typical program, the processor first stores arguments, which are input, into the stack at the caller of the subroutine (S100), and, furthermore, stores into the stack a program address immediately after the call portion as a return address after the end of the subroutine (a return from the subroutine) (S110). The processor then branches to the start address of the subroutine and initiates the subroutine (S120).

In contrast, the identifiers indicated in FIGS. 4A and 4B rather than the address itself are stored upon the subroutine call of the switchable program according to the present embodiment, considering that the processors are to be switched therebetween.

Specifically, as shown in FIG. 5B, in the caller of the subroutine, the processor first stores arguments, which are input, into the stack (S100). Then, unlike FIG. 5A, as the return from the subroutine, the processor stores the identifier included in the program address lists described with reference to FIGS. 4A and 4B as a return point ID rather than storing the program address itself which is immediately after the call portion of the subroutine (S111). Then, the processor branches to the start address of the subroutine and initiates the subroutine (S120).

FIG. 5B shows the case where the subroutine call is not the processor switching point. In the present embodiment, the subroutine call can be determined as the processor switching point. FIG. 5C shows an example of the switchable program where the subroutine call is the processor switching point.

Specifically, when the subroutine call is determined as the processor switching point in the switchable programs, the subroutine call is made via the system call (S200). It should be noted that the system call (S200) is by way of example of the switch programs, and is, specifically, the switch program 220 for processor A, the switch program 221 for processor B shown in FIG. 1, and the like.

In the caller of the subroutine, the processor first stores arguments, which are input, into the stack (S100), and stores the return point ID (S111). The processor then invokes the system call (S200) using the address identifier of the branch target subroutine as input (S112).

The following describes the processing of the system call (S200).

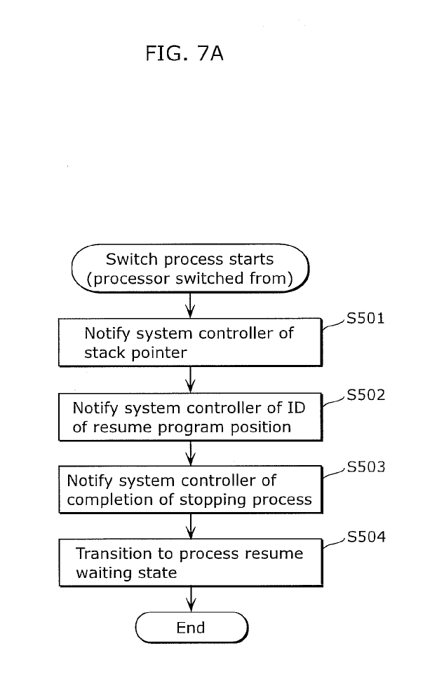

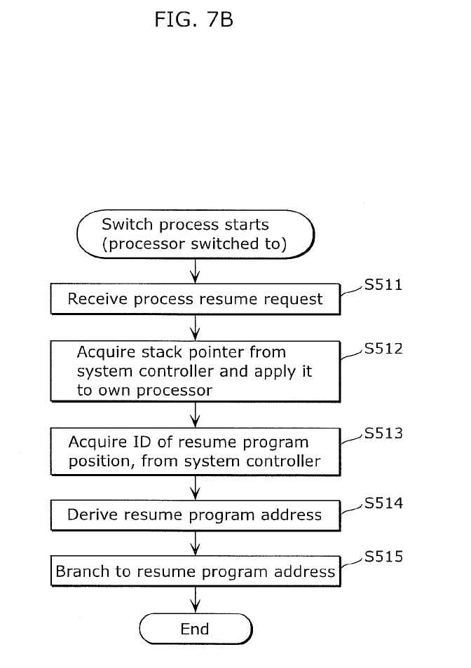

First, the processor checks if the processor switch request is issued from the system controller 130 (specifically, the processor switching control unit 131) (S201). If the processor switch request is issued (Yes in S202), the processor activates processor switch sequence of FIG. 7A described below (S205).

If the processor switch request is not issued (No in S202), the processor derives a branch target program address (the subroutine address) of the subroutine from the address identifier of the subroutine (S203). The processor then branches to the subroutine address and initiates the subroutine (S204).

As described above, when the call portion of the caller of the subroutine is determined as the switch point, the switchable programs according to the embodiment of the present invention include a process for causing the system call at the switch point (S112). This allows the processor switching process to be performed when the system controller 130 requests the processors to be switched therebetween.

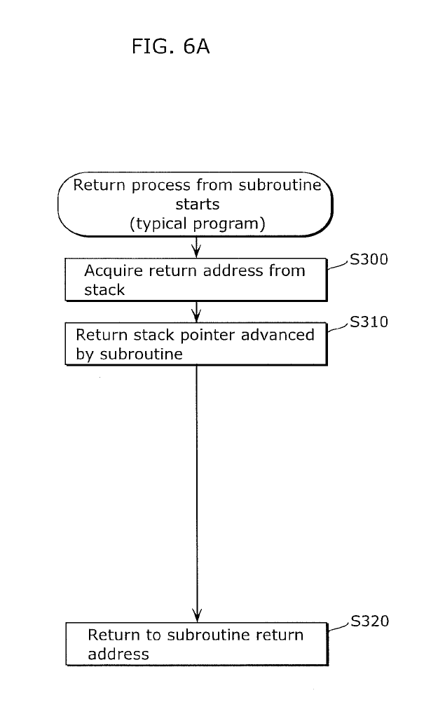

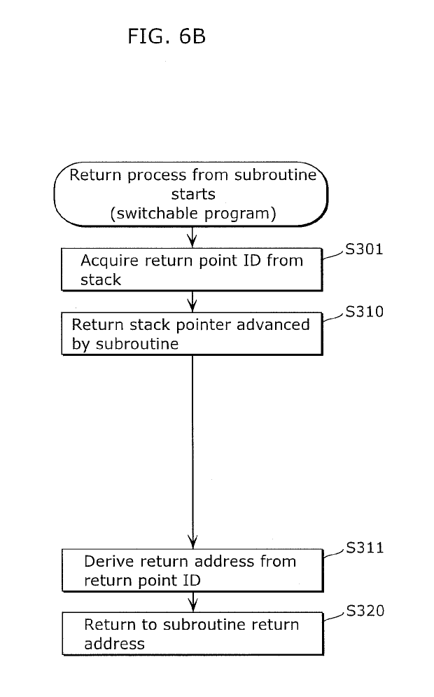

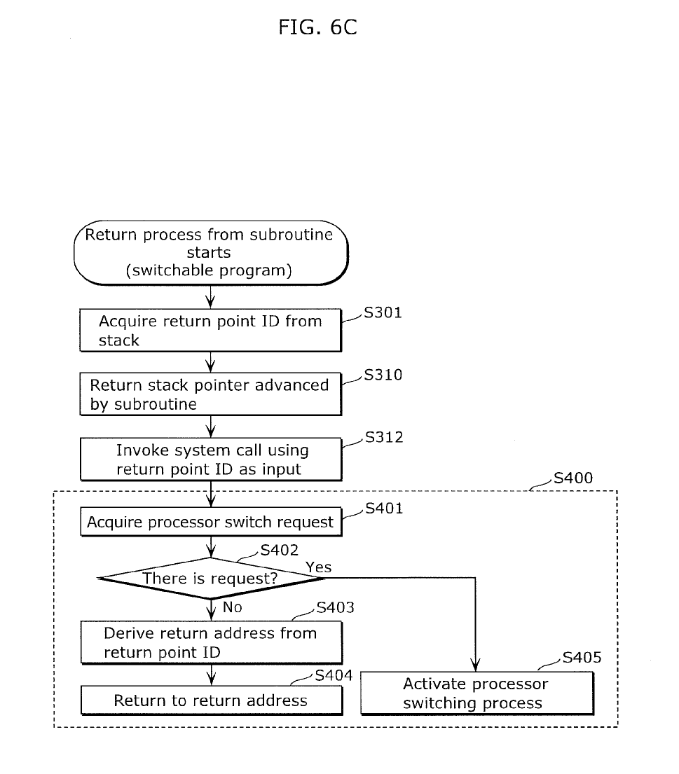

FIGS. 6A, 6B, and 6C are diagrams each showing an example of a program of a return process from the subroutine according to the embodiment of the present invention. Initially, a typical program of the return process from the subroutine, that is, a typical return process from the subroutine will be described, with reference to FIG. 6A.

The processor first acquires a subroutine return address from the stack in the callee of the subroutine of the typical program (i.e., the end of the subroutine in execution) (S300). Then, the processor returns a stack pointer advanced by the subroutine (S310), and returns to the subroutine return address (S320).

In contrast, in the typical return process from the subroutine in the switchable programs according to the embodiment of the present invention, as shown in FIG. 6B, the processor first acquires an identifier (the return point ID) of a return address from the stack, rather than the return address (S301). The processor then returns the stack pointer advanced by the subroutine (S310).

The processor thereafter refers to the program address lists shown in FIGS. 4A and 4B to convert the return point ID into the subroutine return address (S311). The processor then returns to the subroutine return address (S320).

It should be noted that FIG. 6B shows the case where the return from the subroutine is not the processor switching point. In the present embodiment, the return from the subroutine can be determined as the processor switching point. FIG. 6C shows an example of the switchable program where the return from the subroutine is the processor switching point.

Specifically, in the switchable program, to determine the return from the subroutine as the processor switching point, the processor first acquires the return point ID from the stack (S301). Then, the processor returns the stack pointer advanced by the subroutine (S310), and issues the system call (S400) using the return point ID as input (S312). It should be noted that the system call (S400) is by way of example of the switch program, and, specifically, is the switch program 220 for processor A or the switch program 221 for processor B shown in FIG. 1.

The following is the processing of the system call (S400).

First, the processor checks if the processor switch request is issued from the system controller 130 (specifically, the processor switching control unit 131) (S401). If the processor switch request is issued (Yes in S402), the processor activates the processor switch sequence of FIG. 7A described below (S405).

If the processor switch request is not issued (No in S402), the processor derives a program address (the subroutine return address) from the return point ID (S403), and returns to the subroutine return address (S404).

As described above, when the end of the callee for the subroutine is determined as a switch point, the switchable programs according to the embodiment of the present invention include a process for causing the system call at the switch point (S312). This allows the processor switching process to be performed when the processor switch is requested from the system controller 130.

As described above, in the multiprocessor system 10 according to the present embodiment, if there is request from the system controller 130, the processor switching process is performed. Then, if there is no request from the system controller 130, the subroutine call or the return from the subroutine is executed.

FIG. 7A is a flowchart illustrating an example operation of the processor switched from in the system call. FIG. 7B is a flowchart illustrating an example operation of the processor switched to in the system call.

The processor switched from, first, notifies the system controller 130 of the stack pointer at the switch point (S501). Furthermore, the processor switched from notifies the system controller 130 of the identifier (the return point ID) of the branch target program address (S502).

Here, the return point ID is the identifier stored in the stack in step S111 of FIG. 5B or 5C, and is read out from the stack. Optionally, the return point ID is the identifier read out from the stack in S301 of FIG. 6B or 6C. It should be noted that either one of the notification of the stack pointer (S501) and the notification of the return point ID (S502) may be performed prior to the other.

Then, the processor switched from notifies the system controller 130 of completion of stopping the process (S503). Thereafter, the processor switched from, assuming that the process is to be performed by the processor switched from again, transitions to a process resume waiting state (S504). Here, in view of low power, it is desirable that the processor is stopped or paused. Moreover, it is desirable that, if the processor switched from is of multitasking system, the processor switched from transfers the execute right to another task.

The processor switched to, first, receives a process resume request (S511). Then, the processor switched to acquires the stack pointer from the system controller 130 and applies the stack pointer to the own processor (S512). Furthermore, the processor switched to acquires an identifier (the return point ID) of a resume program address (S513).

Next, the processor switched to derives a program address from the acquired identifier by referring to the program address lists as shown in FIGS. 4A and 4B (S514). Then, the processor switched to resumes the processing by branching to the derived program address (S515). This allows the processor switched to to resume the processing at a program address which corresponds to a position at which the processor switched from has suspended the processing and at a stack pointer when the processor is suspended.

It should be noted that the system call shown in FIGS. 5C and 6C can be implemented also by utilizing a processor function having functionality equivalent to the system call. For example, the request from the system controller 130 may be determined from a processor register or a specific data memory in the subroutine call instructions or the subroutine return instructions of the processor. Then, if no request, typical subroutine call instructions or typical subroutine return instructions are executed, and if there is the request, the system call the processing of which is suspended is operated. This can reduce processing overhead in the typical subroutine call or the typical subroutine return instructions when there is no request.

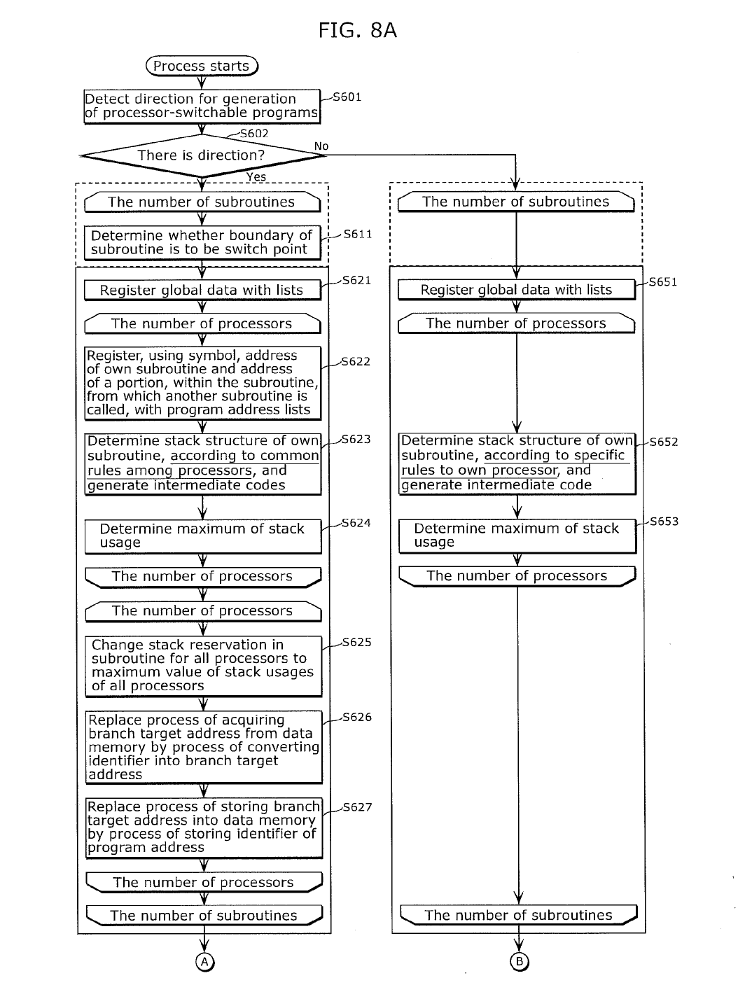

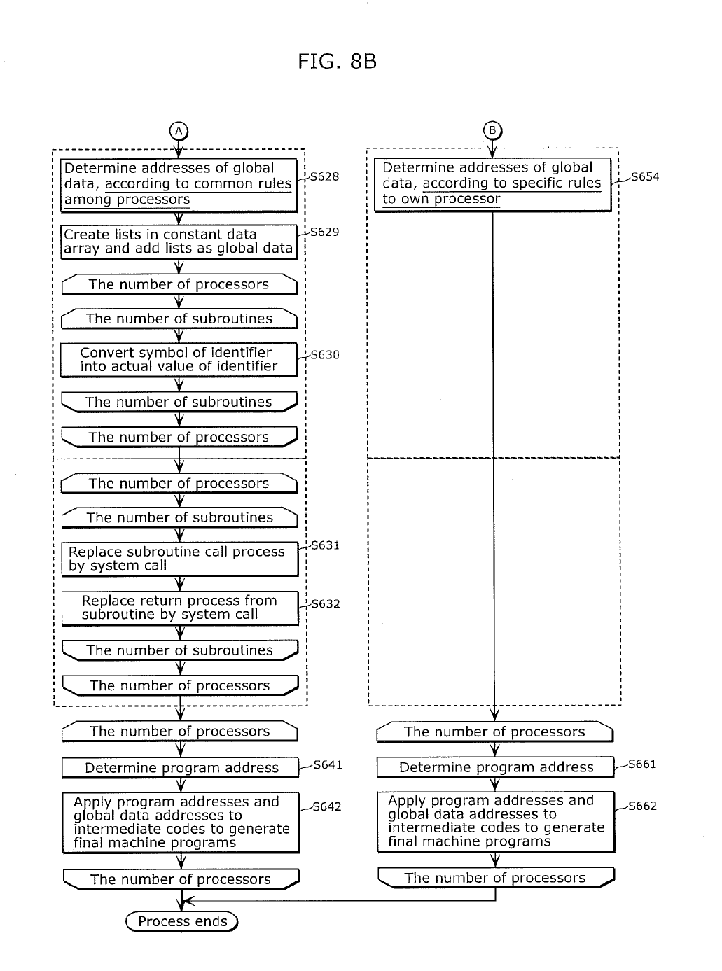

Subsequently, an example of the method for generating the switchable program according to the embodiment of the present invention will be described. FIGS. 8A and 8B are flowcharts each illustrating an example operation of the program generation device 20 according to the embodiment of the present invention.

First, the switchable-program generation activation units 300 and 310 sense whether the direction for the generation of the processor-switchable programs is given (S601). In other words, the switchable-program generation activation units 300 and 310 determine whether direction to generate the switchable programs is given from the switchable-program generation direction unit 110.

If there is no direction for the generation of the processor-switchable programs (No in S602), the program generation device 20 generates, as below, typical machine programs, that is, machine programs dedicated to respective processors.

The switch point determination units 301 and 311 are not required for the creation of the typical machine programs, and thus disabled. When generating the typical machine programs, the switchable-program generation units 302 and 312 each generate a program according to the processor-specific rules, without considering achieving switchable programs.

First, the switchable-program generation units 302 and 312 register global data with the respective lists (S651).

Next, the switchable-program generation units 302 and 312 determine a stack structure of the subroutine, according to specific rules best suited for the hardware configurations and the configurations of the instruction sets of the processors. Then, based on the determined stack structure, the switchable-program generation units 302 and 312 generate intermediate codes for generating the machine programs (S652). Herein, the intermediate codes are programs in which addresses of the program and data items are represented by symbols determined irrespective of the relationship of the program and the data items with other subroutines and global data items.

Furthermore, the switchable-program generation units 302 and 312 add global data for use to the respective lists (S653). The intermediate code of all the subroutines and the list of global data are created by repeating for each processor and each subroutine the above described generation of intermediate code (S652) and addition of global data to the list (S653).

Then, based on the created global data list, the switchable-program generation units 302 and 312 determine an address of each global data item, according to the specific rules appropriate for the hardware characteristics of the respective processors (S654).

The switch decision process insertion units 303 and 313 are not required for the creation of the typical machine programs, and thus the processing thereof is disabled.

Last, how all the subroutines are linked will be described.

First, the switchable-program generation units 302 and 312 determine a program address of each subroutine (S661). Then, the switchable-program generation units 302 and 312 apply branch addresses and global data addresses to the intermediate code to create the final machine programs (S662).

Subsequently, the case where the direction for the generation of the processor-switchable program is detected (Yes in S602) will be described.

First, the switch point determination units 301 and 311 determine, for each subroutine, whether a boundary of the subroutine is to be a candidate for subroutine switch point (S611). The boundary of the subroutine is, for example, the call portion of the caller of the subroutine or at least one of the beginning and end of the callee of the subroutine.

Herein, all the subroutines may be determined as candidates for subroutine switch point. Alternatively, whether to determine a boundary of the subroutine as the switch point may be determined relative to the number of static or dynamic steps of the subroutine or the depth of nesting of the subroutine. Details of the example of the switch point will be described.

Next, the switchable-program generation units 302 and 312 first register global data with lists (S621).

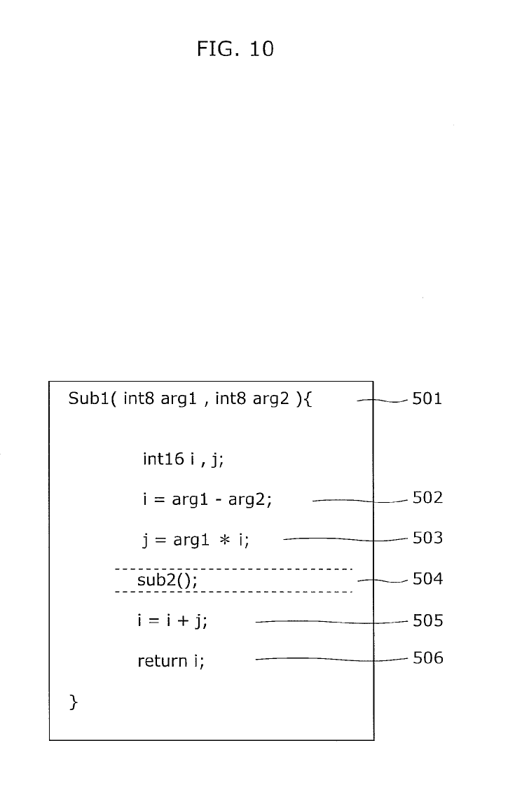

Furthermore, using symbol, the switchable-program generation units 302 and 312 register for each processor the address of the own subroutine and an address of a portion, within the subroutine, from which another subroutine is called, with the program address lists shown in FIGS. 4A and 4B (S622). Furthermore, the switchable-program generation units 302 and 312, as described with reference to FIGS. 3A to 3C, determine the stack structure using the common rules among the plurality of processors, and generate the intermediate codes (S623). Herein, as described below with reference to FIGS. 10, 11, and 12, the switchable-program generation units 302 and 312 operate the state of data at boundaries of the subroutine so that consistency of the working data in the stack is guaranteed. Herein, an amount of updating the stack pointer is set as a temporary value in the own processor.

Next, the switchable-program generation units 302 and 312 temporarily determine the maximum of the stack usages of the subroutine for all the processors (S624). Then, the switchable-program generation units 302 and 312 change the stack reservation in the subroutine for all the processors to the maximum value of the stack usages of all the processors (S625). Specifically, the switchable-program generation units 302 and 312 replace the amount of updating the stack temporarily set in step S623 by the maximum stack usage as the stack usage of the subroutine common to all the processors.

Moreover, the switchable-program generation units 302 and 312 replace the process which acquires the branch target address from the data memory 50, such as the process which acquires the subroutine return address from the stack, by a process which converts the identifier into a branch target address (S626). Specifically, the switchable-program generation units 302 and 312 replace the typical process of address acquisition by a method of acquiring the branch target address from the identifier by referring to the program address lists shown in FIGS. 4A and 4B. More specifically, the switchable-program generation units 302 and 312 replace the process of step S300 illustrated in FIG. 6A by the process of step S301 illustrated in FIGS. 6B and 6C. In the present embodiment, in this step, the identifier is not determined because not all modules are checked. Thus, the switchable-program generation units 302 and 312 create intermediate codes, using symbols such as a name of a module.

Moreover, the switchable-program generation units 302 and 312 extract a process which stores the branch target address into the data memory 50, such as a process, at the subroutine call, which stores a return address, and replace the process which stores the return address by a process which stores an identifier (S627). Specifically, the switchable-program generation units 302 and 312 replace a typical address store process by a method of converting the branch target address into an identifier and storing the identifier, by referring to the program address lists of FIGS. 4A and 4B. More specifically, the switchable-program generation units 302 and 312 replace the process of step S110 illustrated in FIG. 5A by the process of step S111 illustrated in FIGS. 5B and 5C. In the present embodiment, in this step, the switchable-program generation units 302 and 312 create programs as intermediate codes using symbols because not all identifiers of the branch target program addresses are determined.

After repeating from the determination of the switch point (S611) to the replacement of the store process (S627) described above for each subroutine, the switchable-program generation units 302 and 312 next determine addresses of the global data, using the common rules among the plurality of processors (S628). This allows the global data to be shared between the processors.

Furthermore, the switchable-program generation units 302 and 312 determine actual values of all identifiers from the symbols of the identifiers registered with the program address lists. Then, the switchable-program generation units 302 and 312 create lists of the actual values in constant data arrays, and add the created lists as global data (S629).

Next, the switchable-program generation units 302 and 312 convert the symbol, generated in step S627, of the identifier of the branch target program address into the actual values generated in step S629 (S630). The conversion process is performed with respect to all the processors for each processor.

Next, the switch decision process insertion units 303 and 313 insert a process, which calls the system call, at the processor switching point determined in step S611 and into a target subroutine. Specifically, the switch decision process insertion units 303 and 313 replace the subroutine call process by the system call (step S200 in FIG. 5C) (S631). Moreover, the switch decision process insertion units 303 and 313 also replace the return process from the subroutine by the system call (step S400 in FIG. 6C) (S632). These replace processes are performed with respect to all the processors for each processor.

Last, how all the subroutines are linked will be described.

First, the switchable-program generation units 302 and 312 determine program addresses from the intermediate codes previously created (S641). Then, the switchable-program generation units 302 and 312 apply the determined branch target addresses, global data addresses, and branch target address identifiers to the intermediate codes to generate final machine programs (S642).

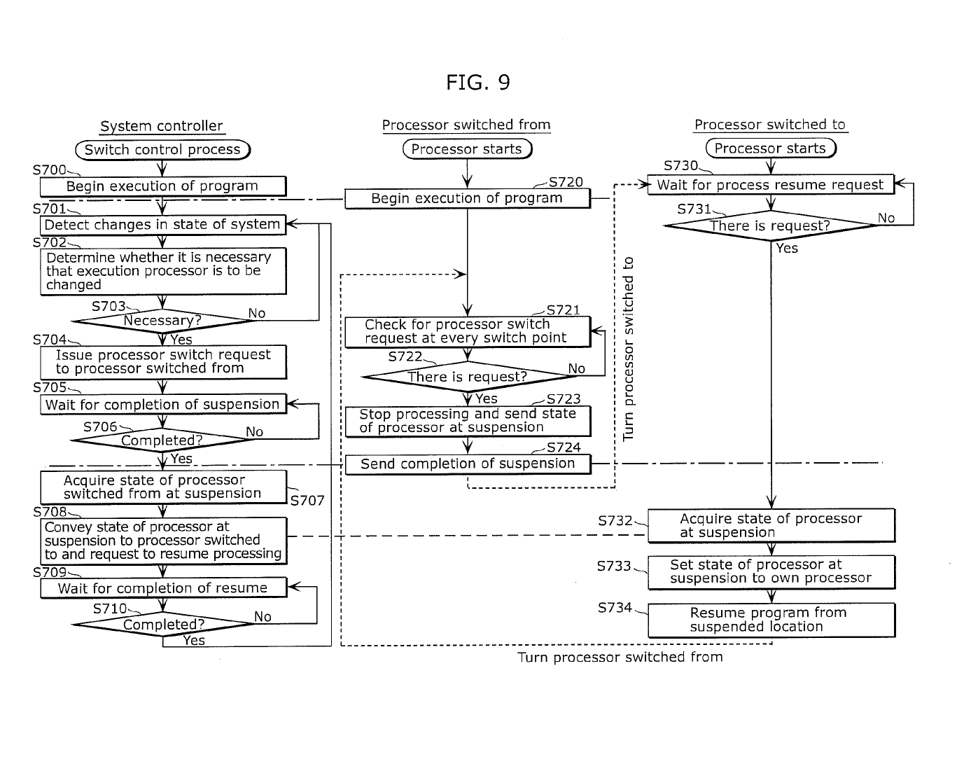

FIG. 9 is a sequence diagram showing an example operation of the multiprocessor system 10 according to the embodiment of the present invention.

First, the system controller 130 determines a processor for first executing a program and causes the processor to begin execution of the program (S700). Herein, description will be given where the processor for first executing the program, that is, the processor switched from is the processor A120, and the processor switched to is the processor B121.

After causing the execution of the program, the system controller 130 continuously detects changes in the state of the system (S701), and determines whether it is necessary that the execution processor is to be changed (S702). The determination is made by, for example, detecting which processor is executing what program in addition to the above program or execution request is issued with respect to what program, and referring to a table or the like which indicates a processing time it takes for each processor to process each program. For example, if one desires to minimize power, the system controller 130 finds an allocation combination of a processor and a program so that a minimum number of processors can achieve all the functionality in real time. Then, if a new allocation is different from the allocation of the current processor executing a program, the system controller 130 determines that the switching process is necessary.

When determined that the switching process is necessary (Yes in S703), the system controller 130 issues a switch request to the processor A120 which is the processor switched from (S704). Then, the system controller 130 waits for the completion of suspension of the processing at the processor switched from (S705).

When the suspension process is completed (Yes in S706), the system controller 130 acquires a state of the processor switched from at the suspension (S707). Specifically, the system controller 130 acquires information on the stack pointer of the processor switched from at the suspension and a resume address. It should be noted that the system controller 130 may determine that the suspension process is completed by receiving such information (context) indicative of the state of the processor at the suspension. Alternatively, the system controller 130 may determine that the suspension process is completed by receiving a notification indicative of the completion of the suspension process from the processor switched from.

Then, based on the information indicative of the state of the processor at the suspension, the system controller 130 requests the processor B121, which is the processor switched to, to resume the processing (S708). Then, the system controller 130 waits for the notification indicative of completion of resume, from the processor switched to (S709), and once received the completion notification (Yes in S710), resumes detecting the changes in the state of the system.

The processor A120 which is the processor switched from, first, begins execution of the switchable program (S720), and then, while executing the program, checks if there is a processor switch request from the system controller 130 at the switch point (S721).

Then, if there is the switch request (Yes in S722), the processor A120, as described with reference to FIG. 7A, notifies the system controller 130 of the information (context) at a suspension point (the switch point) and the completion of the suspension (S723 and S724). Then, from this point, the processor A120 stops itself in a wait state for the process resume request which is similar to the initial state of the processor switched to, so as to resume the above processing. In other words, the processor A120 which has been the processor switched from turns the processor switched to in the multiprocessor system 10.

The processor B121 which is the processor switched to is in the wait state for the process resume request (S730). The processor B121 continues waiting for the resume request. When received the request (Yes in S731), the processor B121 acquires the state of processor at the suspension from the system controller 130, according to procedure illustrated in FIG. 7B (S732).

Then, the processor B121 sets the own processor to the state of processor at the suspension (S733), and resumes the processing from the resume address, that is, the switch point (S734). Hereinafter, the processor B121, which has been the processor switched to, turns the processor switched from in the multiprocessor system 10.

Herein, an example of the processor-switchable program will be described.

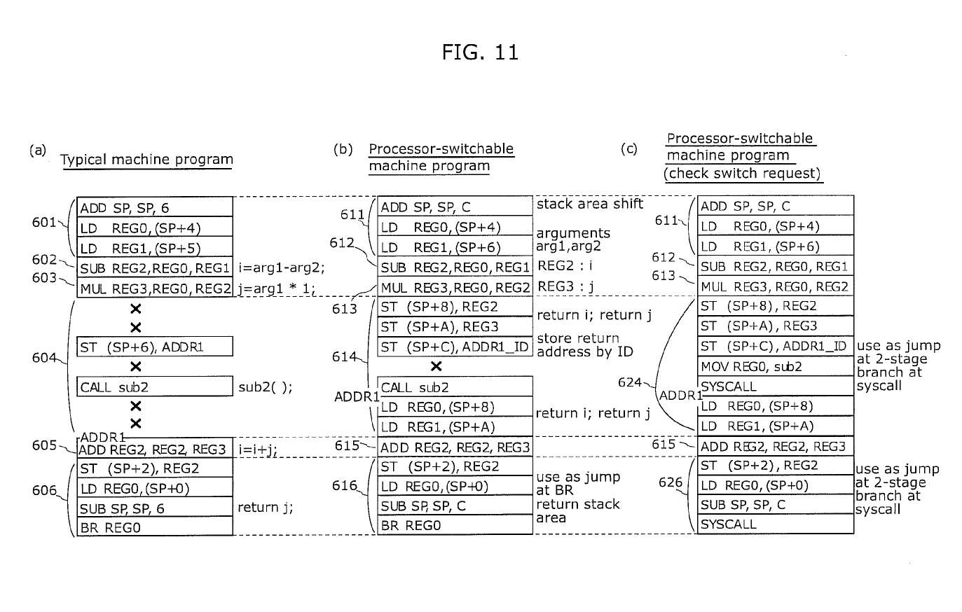

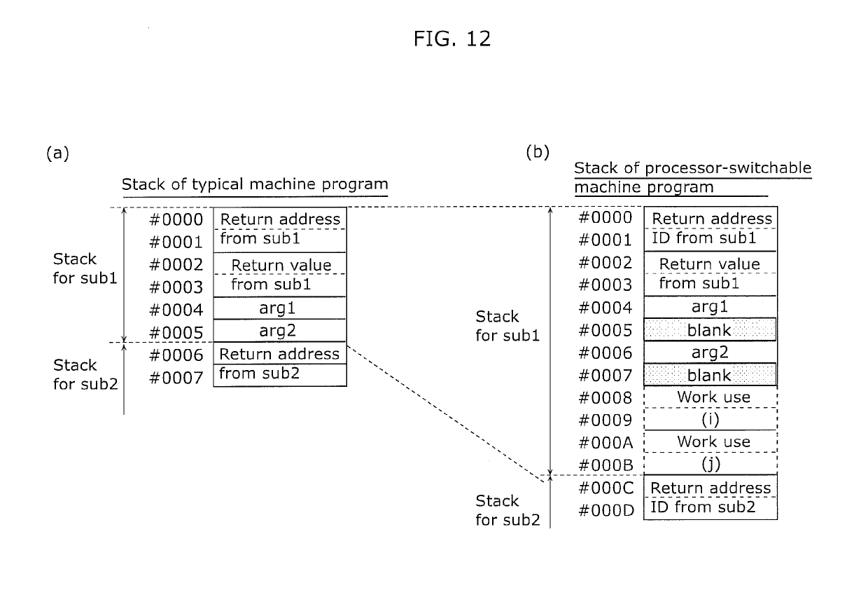

FIG. 10 shows an example of the source program according to the embodiment of the present invention. FIG. 11 is a diagram showing an example of the typical machine program and the processor-switchable machine program. FIG. 12 is a diagram showing an example of the stack structure according to the embodiment of the present invention.

First, the typical machine program will be described, with reference to (a) of FIG. 11.

A machine code 601 shown in (a) of FIG. 11 corresponds to a source code 501 shown in FIG. 10. Specifically, the machine code 601 reads out the argument arg1 from an address #0004 of the stack shown in (a) of FIG. 12, and stores the argument arg1 into the register REG0, and reads out an argument arg2 from an address #0005 and stores the argument arg2 into the register REG1.

A machine code 602 corresponds to a source code 502 shown in FIG. 10. Specifically, the machine code 602 first subtracts the argument arg2 stored in the register REG1 from the argument arg1 stored in the register REG0, and stores the subtraction result (arg1−arg2) into a register REG2. This stores a variable i (=arg1−arg2) in the register REG2.

A machine code 603 corresponds to a source code 503 shown in FIG. 10. Specifically, the machine code 603 multiplies the argument arg1, stored in the register REG0, by the subtraction result stored in the register REG2, that is, the variable i (=arg1−arg2), and stores the multiplication result into a register REG3. This stores a variable j (=arg1*i) in the register REG3.

A machine code 604 corresponds to a source code 504 shown in FIG. 10. Specifically, to call a subroutine sub2, the machine code 604 stores, as a return from the subroutine sub2, a starting program address ADDR1 of a machine code 605 following subroutine call instructions (“CALL sub2”), into the stack (addresses #0006 and #0007) shown in (a) of FIG. 12. Then, the machine code 604 calls the subroutine sub2 and performs processing of the subroutine sub2.

Then, the machine code 604 reads out the return address from the stack to return from the subroutine sub2, and executes the machine code 605. The machine code 605 corresponds to a source code 505 shown in FIG. 10. Specifically, the machine code 605 adds the variable i stored in the register REG2 and the variable j stored in the register REG3, and stores the addition result (i+j) into the register REG2. This stores the variable i (=i+j) in the register REG2.

A machine code 606 corresponds to a source code 506 shown in FIG. 10. First, the machine code 606 stores, as a return value from a subroutine sub1, the variable i stored in the register REG2 into the stack (addresses #0002 and #0003) shown in (a) of FIG. 12. Then, the machine code 606 acquires, from the stack (addresses #0000 and #0001), a return address from the subroutine sub1 and stores the return address into the register REG0. Last, the machine code 606 returns the stack pointer to its original position, and returns to the return address stored in the register REG0.

Next, a processor switchable machine program will be described, with reference to (b) of FIG. 11. Part (b) of FIG. 11 corresponds to FIG. 5B, showing the case where a branch of the subroutine is not a switch point.

In the present embodiment, the common rules are provided in which subroutine arguments specified in the source program and temporary data are always reserved into a stack, and compliers of all the processors generate switchable programs, according to the common rules. The common rules also include that there is no guarantee that working data other than the data reserved in the stack, and data stored in the registers all remain across subroutines.

For example, the switchable-program generation units 302 and 312 generate the switchable programs so that the values, which are stored in the register before the switch point and utilized after the switch point, are stored in the stack area of the data memory 50. This guarantees that necessary data survives in the stack even if the processors are switched therebetween when the data crosses a subroutine. Hereinafter, a program created under the common rules will be described.

First, a machine code 611 shown in (b) of FIG. 11 corresponds to the source code 501 shown in FIG. 10. In other words, by executing the machine code 611, the arguments arg1 and arg2 are extracted from the stack. Specifically, the argument arg1 and the argument arg2 are read out from the address #0004 and the address #0006, respectively, of the stack shown in (b) of FIG. 12 and stored in the register REG0 and the register REG1, respectively.

Next, a machine code 612 corresponds to the source code 502 shown in FIG. 10. The machine code 612 is the same as the machine code 602, and thus the description will be omitted.

A machine code 613 corresponds to the source code 503 shown in FIG. 10. The machine code 613 is the same as the machine code 603, and thus the description will be omitted.

A machine code 614 corresponds to the source code 504 shown in FIG. 10. Herein, the subroutine sub2 is executed and thus the processors are likely to be switched therebetween. Therefore, it is necessary to save the values in the registers into the stack.

Specifically, first, the machine code 614 stores the variable i (=arg1−arg2) stored in the register REG2 into the stack area (addresses #0008 and #0009) for the variable i. The machine code 614 also stores the variable j (=arg1*i) stored in the register REG3 into the stack area (addresses #000A and #000B) for the variable j. Since the machine code 614 follows the common rules that data items in registers do not survive across the subroutines, the working data items i and j are saved into the reserved stack.

Then, the machine code 614 stores, as a return from the subroutine sub2, information on the starting program address of a machine code (“LD REG0, (SP+8)”) following the subroutine call instructions (“CALL sub2”), into a stack (addresses #000C and #000D). Specifically, the address identifier shown in FIGS. 4A and 4B, rather than the program address itself, is stored. Then, the machine code 614 calls the subroutine sub2 and performs the processing of the subroutine sub2.

Subsequently, the machine code 614 reads out the variables i and j saved in the stack when returning from the subroutine sub2. Specifically, the machine code 614 reads out the variable i from the address #0004 of the stack shown in (a) of FIG. 12, and stores the read variable i into the register REG0. The machine code 614 also reads out the variable j from the address #0006 of the stack and stores the read variable j into the register REG1.

A machine code 615 corresponds to the source code 505 shown in FIG. 10. The machine code 615 is the same as the machine code 605, and thus the description will be omitted.

Last, a machine code 616 corresponds to the source code 506 shown in FIG. 10. Herein, similarly to the machine code 606, the machine code 616 performs the return process from the subroutine sub1. Here, as can be seen from (a) and (b) of FIG. 12, the typical machine program shown in (a) of FIG. 11 and the processor-switchable machine program shown in (b) of FIG. 11 use stack areas having different sizes. Therefore, the machine code 616 and the machine code 606 are different only in the process which returns the stack pointer to its original position.

Part (c) of FIG. 11 corresponds to FIG. 5C, showing the case where a branch of the subroutine is a switch point. It should be noted that the same reference signs will be used to refer to the same machine codes shown in (b) of FIG. 11, and the description will be omitted herein.

As described above, when the branch of the subroutine is the switch point, the system call executes the subroutine. Thus, the machine program shown in (c) of FIG. 11 includes machine codes 624 and 626 for calling the system call, instead of the machine codes 614 and 616, respectively.

The machine code 624 corresponds to the source code 504 shown in FIG. 10. Similarly to the machine code 614, the machine code 624 saves the variables i and j into the stack and, as the return from the subroutine sub2, stores an identifier (ADDR1_ID) of the starting program address of a machine code (“LD REG0, (SP+8)”) following the system call (“SYSCALL”), into the stack (the addresses #000C and #000D).

Then, the machine code 624 stores the identifier of the address of the subroutine sub2 (not the address itself) into the register REG0. The identifier stored in the register REG0 is utilized as information on where to jump in branching to the subroutine sub2, when there is no processor switch request in the processing of the system call.

Then, the system call (“SYSCALL”) is executed. For example, step S200 illustrated in FIG. 5C is performed. Hereinafter, if there is no processor switch request, the machine code 624 reads out the variables i and j saved in the stack and stores the read variables i and j into the registers REG0 and REG1, respectively.

A machine code 626 corresponds to the source code 506 shown in FIG. 10. Herein, similarly to the machine code 616, the machine code 626 performs the return process from the subroutine sub1. Here, similarly to when branching to the subroutine sub2, the machine code 626 executes the system call, thereby determining the processor switch request.

FIG. 12 is a diagram showing an example of a stack structure according to the embodiment of the present invention.

As shown in (a) of FIG. 12, in the typical program, minimum areas which are from #0000 to #0005 used by a certain processor to execute the subroutine sub1 are reserved in the stack. In contrast, in the processor-switchable program, as shown in (b) of FIG. 12, areas from #0000 to #000B are reserved in case some other processor may require a larger number of working areas due to an insufficient number of registers. Thus, the areas from #0000 to #000B are reserved, although which is not required by the processor. Therefore, as shown in (b) and (c) of FIG. 11, upon initialization of the stack pointer, the stack pointer is moved by #000C (hexadecimal) which is greater than the initial value of the stack pointer shown in (c) of FIG. 11.

As described above, in the processor-switchable programs, the amounts of stack to be guaranteed upon calling and returning from the subroutine sub2, the stack content, and the registers are commonly shared between the processors. Thus, the processing can be continued even when the processors are switched therebetween.

Herein, a specific example of the switch point determined by the switch point determination units 301 and 311 will be described.

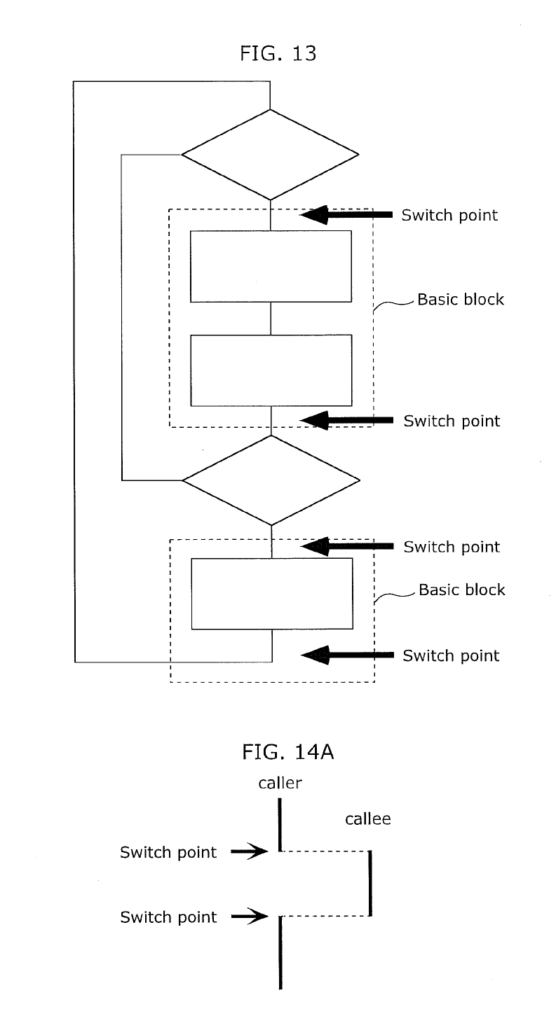

FIG. 13 is a diagram illustrating an example in which boundaries of the basic block are determined as the switch points in the embodiment according to the present invention.

As described above, the switch point determination units 301 and 311 according to the embodiment of the present invention determine at least a portion of the boundaries of the basic block of the source program as a switch point. The basic block refers to a portion which does not branch or merge in halfway through a program, and is, specifically, a subroutine.

As shown in FIG. 13, the switch point determination units 301 and 311 according to the embodiment of the present invention determine the beginning and end which are boundaries of the basic block, as the switch points. It should be noted that the switch point determination units 301 and 311 may not determine the beginning and end of all basic blocks as the switch points. In other words, the switch point determination units 301 and 311 may selectively determine switch points from among boundaries of a plurality of basic blocks included in the program.

Thus, the basic block is a group of processes which include no branch nor merge in halfway through. Therefore, setting the boundaries of the basic block as the switch points can facilitate management of the switch points.

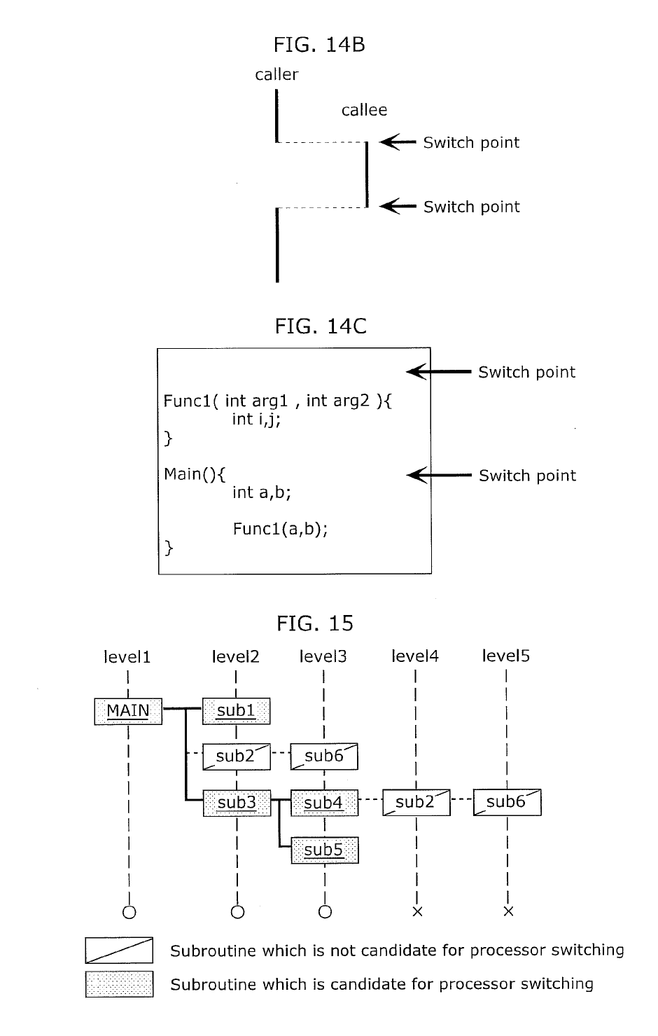

FIGS. 14A, 14B, and 14C are diagrams each illustrating an example in which the boundary of the subroutine is determined as the switch point in the embodiment according to the present invention. As described above, the switch point determination units 301 and 311 may determine the boundary of the subroutine, which is by way of example of the basic block, as the switch point.

For example, the switch point determination units 301 and 311, as shown in FIG. 14A, determine the call portion of the caller of the subroutine as the switch point. The specific operation here is as shown in FIG. 5C. Likewise, the switch point determination units 301 and 311 may also determine the return portion of the caller of the subroutine as the switch point.

Moreover, the switch point determination units 301 and 311 may also determine the beginning of the callee of the subroutine as the switch point as shown in FIG. 14B. Alternatively, the switch point determination units 301 and 311 may determine the end of the callee of the subroutine as the switch point. The specific operation here is as shown in FIG. 6C.

Taking the example of the source program, as shown in FIG. 14C, the switch point determination units 301 and 311 can determine the beginning of a function Func1 which is a subroutine, as the switch point. The switch point determination units 301 and 311 also can determine the beginning of the main routine as the switch point.

Thus, determining a boundary of the subroutine as a switch point can facilitate the processor switching. For example, managing the branch target address to the subroutine and the return address from the subroutine in association between the processors can facilitate the continuation of the processing at the processor switched to. Specifically, the branch target address to the subroutine and the return address from the subroutine are managed in association among the plurality of processors. Then, the processor switched to acquires a corresponding branch target address or a corresponding return address, thereby facilitating the continuation of the processing.

As described above, the program generation device according to the embodiment of the present invention includes: the switch point determination unit which determines a predetermined location in the source program as the switch point; the program generation unit which generates, for each processor, the switchable program, which is the machine program, from the source program so that the data structure of the memory is commonly shared at the switch point among the plurality of processors; and the insertion unit which inserts the switch program into the switchable program. In the present embodiment, the switch program is a program for stopping a switchable program that corresponds to the first processor and is being executed by the first processor at the switch point, and causing the second processor to execute, from the switch point, a switchable program that corresponds to the second processor.

In the present embodiment, the data structure of the memory is the same at the switch point. Therefore, executing the switch program can switch the processors therebetween. Switching the processors, herein, is stopping the processor which is executing a program, and causing another processor to execute a program from the stopped point.

Thus, the second processor can continue the execution of the task being executed by the first processor. In other words, the execution processor suspends the processing in a state of data memory whereby another processor can continue the processing, and the other processor takes over the state of data memory and resumes processing at a corresponding program position in the program switched to, thereby continuing the processing while sharing the same data memory, keeping the consistency.

In short, according to the above configuration, the switchable programs for different processors having different instruction sets are generated which are the machine programs generated in the cross compiler environment. In the switchable program, based on the request from the system controller, the processor executing the processing senses, using the system call, the processor switch request at a spot where the data memory remains consistent, suspends the processing, and saves the state of the processor. Then, the processor switched to takes over the saved state of the processor, and resumes processing, thereby the execution processors while keeping the consistency of the processing to be switched therebetween.

Thus, according to the embodiment of the present invention, even when the processing is executed in the multiprocessor system which includes processors having different instruction sets, the execution processor can be changed. Thus, the system configuration can be flexibly changed according to changes in use state of a device, without stopping a process in execution, thereby improving processing performance and low-power performance of the device.

While, as above, the program generation device, the processor device, the multiprocessor system, and the program generation method according to the present invention have been described with reference to the embodiment, the present invention is not limited to the embodiment. Various modifications to the present embodiments that may be conceived by those skilled in the art and other embodiments constructed by combining constituent elements in different embodiments are included in the scope of the present invention, without departing from the essence of the present invention.

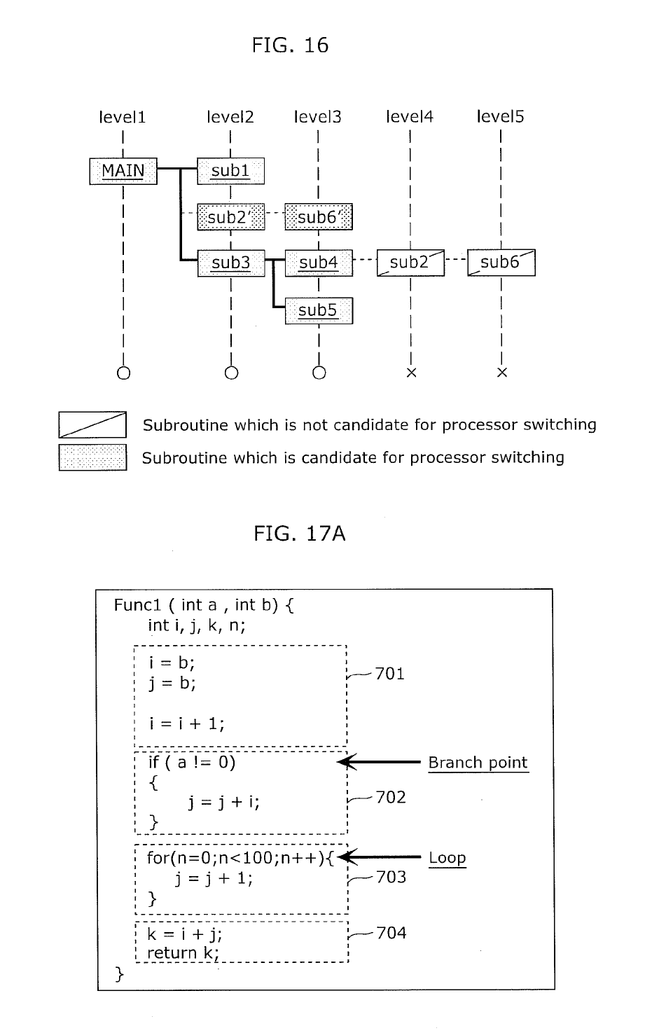

For example, the switch point determination units 301 and 311 according to the embodiment of the present invention may determine the switch point, based on the depth of a level of the subroutine. Specific example will be described, with reference to FIGS. 15 and 16.

FIG. 15 is a diagram illustrating an example in which a switch point is determined based on the depth of a level of a subroutine according to a variation of the embodiment of the present invention.

The switch point determination units 301 and 311 according to the embodiment of the present invention may determine, as the switch point, at least a portion of the boundaries of the subroutine where the depth of a level at which the subroutine is called in the source program is shallower than a predetermined threshold. In other words, the switch point determination units 301 and 311 may exclude boundaries of the subroutine the level of which are deeper than the threshold from the candidates for switch point.

For example, the main routine of the program is regarded as the first level (level 1). Suppose that the threshold here is, for example, the third level (level 3), the switch point determination units 301 and 311 determine boundaries of the subroutines up to those at the third level as the switch points. In the example shown in FIG. 15, the boundaries of the main routine, a subroutine 1, and subroutines 3 to 5 are determined as the switch points.

A subroutine 2 and a subroutine 6 are called at the fourth level or the fifth level which is deeper than the third level which is the threshold, and thus excluded from the candidates for switch point by the switch point determination units 301 and 311. In other words, when one subroutine is called at a plurality of different levels, the switch point determination units 301 and 311 determine whether a deepest level of the subroutine among the plurality of different levels is deeper than the threshold, thereby determining whether the boundaries of the subroutine are to be determined as the switch points. The switch point determination units 301 and 311 determine the boundaries of the subroutine as the switch points when a deepest level at which the subroutine is called is shallower than the threshold.

FIG. 16 is a diagram illustrating another example in which the switch point is determined based on the depth of a level of the subroutine according to the variation of the embodiment of the present invention.

As with the example shown in FIG. 15, in the example shown in FIG. 16 also, the switch point determination units 301 and 311 exclude the subroutines the levels of which are deeper than the threshold from the candidates for switch point. The example shown in FIG. 16 is different from the example shown in FIG. 15 in that when the same subroutine is called at a plurality of different levels, the levels of the subroutine are separately determined.

In other words, the switch point determination units 301 and 311 determine whether a level of a subroutine is deeper than the threshold each time the subroutine is called, irrespective of whether the same subroutine is called at a plurality of different levels. In the example shown in FIG. 16, the subroutine 2 is called from the main routine at the second level and also from the subroutine 4 at the fourth level.

Here, the switch point determination units 301 and 311 determine, as the switch points, the boundaries of the subroutine 2 that is called from the main routine at the second level shallower than the threshold. On the other hand, the switch point determination units 301 and 311 exclude the boundaries of the subroutine 2 that is called from the subroutine 4 at the fourth level deeper than the threshold from the candidates for switch point.

As compared to the subroutine that is not a candidate for switch point, the subroutine that is a candidate for switch point is different in machine program. Therefore, the switchable-program generation units 302 and 312 generate machine programs corresponding to two different subroutines from the same source program corresponding to the subroutine 2. In other words, the switchable-program generation units 302 and 312 generate two different machine programs respectively corresponding to the subroutine 2′ that is a candidate for switch point and the subroutine 2 that is not a candidate for switch point.

Thus, determining the subroutines that are called at shallow levels in the hierarchical structure as the candidates for switch point, rather than determining all the subroutine as the candidates for switch point, can limit the number of switch points. A larger number of switch points increases the number of times the switch decision process is performed, which may end up slowing processing the program. Thus, limiting the number of switch points can reduce the slowdown of processing.

The switch point determination units 301 and 311 according to the embodiment of the present invention may determine at least a portion of the branch of the source program as the switch point. Also, here, the switch point determination units 301 and 311 may exclude branches to iterative processes, among branches in the source program, from the candidates for switch point.

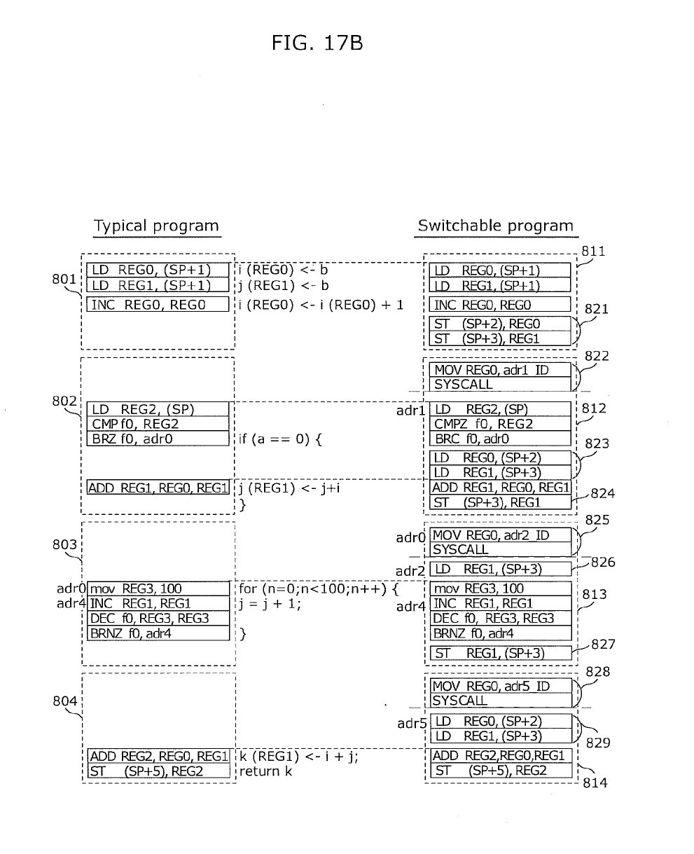

FIG. 17A shows an example of a source program for illustrating an example in which the switch point is determined based on a branch point according to the variation of the embodiment of the present invention. FIG. 17B shows an example of a machine program corresponding to the source program shown in FIG. 17A.

As shown in FIG. 17A, the switch point determination units 301 and 311 determine, as switch points, branch points, such as, if processing. On the other hand, the switch point determination units 301 and 311 exclude, from the candidates for switch point, branches to iterative processes, such as, for processing.

First, the relationship between a source program shown in FIG. 17A and a typical machine program shown in FIG. 17B will be described. The case is assumed where an argument a is stored in an area indicated by a stack pointer SP and an argument b is stored in an area indicated by the stack pointer SP+1 in the stack.

A source code 701 shown in FIG. 17A corresponds to a machine code 801 shown in FIG. 17B. Specifically, the source code 701 reads out the argument b from the stack and stores the argument b into the registers REG0 and REG1. The value of the register REG0 corresponds to the variable i, and the value of the register REG1 corresponds to the variable j. Then, the source code 701 increments the variable i which is the value stored in the register REG0.

A source code 702 corresponds to a machine code 802. Specifically, the source code 702 reads out the argument a from the stack and stores the argument a into the register REG2. Then, the source code 702 compares the value stored in the register REG2 with a value zero. In other words, the source code 702 determines whether the argument a is zero. If the argument is zero, the process proceeds to a program address adr0.

If the argument is not zero, the argument i stored in the register REG0 and the argument j stored in the register REG1 are added together and the addition result is stored in the register REG1. In other words, j+i is calculated and the calculation result is used as a new value of the argument j.

A source code 703 corresponds to a machine code 803. Specifically, the source code 703 first stores a value 100 in the register REG3. It should be noted that a process of storing the value 100 in the register REG3 is the process indicated by the program address adr0. Then, the source code 703 increments the variable j which is the value stored in the register REG1. The increment of the variable j is a process indicated by a program address adr4.

Next, the source code 703 decrements the value stored in the register REG3. If the value stored in the register REG3 is not zero, the process proceeds to the program address adr4. In other words, the variable j is repeatedly incremented until the value stored in the register REG3 is zero.

A source code 704 corresponds to a machine code 804. Specifically, the source code 704 first adds the variable i which is the value stored in the register REG0 and the variable j which is the value stored in the register REG1. The addition result is stored in the register REG2. Then, the addition result stored in the register REG2 is stored into an area indicated by the stack pointer SP+5 in the stack.

The typical machine program generated by converting the source program shown in FIG. 17A according to the processor-specific rules has been described above. In the following, the switchable program generated according to the common rules between the processors according to the variation of the present invention will be described.

A machine code 811 shown in FIG. 17B corresponds to the source code 701. As compared to the machine code 801, the machine code 811 is newly added with a machine code 821 which saves the values stored in the registers into the stack. Specifically, the variable i stored in the register REG0 is stored in an area indicated by the stack pointer SP+2 in the stack, and the variable j stored in the register REG1 is stored in an area indicated by the stack pointer SP+3 in the stack.

This is because the subsequent processing includes subroutines (if processing and for processing), and there is no guarantee that the values in the registers remain across the subroutines. Furthermore, this is because it is necessary to store the variables in the stack of the shared memory for another processor to continue the execution of the program since the processors are likely to switch therebetween when the boundaries of the subroutines are determined as the switch points.

A machine code 812 corresponds to the source code 702. As compared to the machine code 802, the machine code 812 is newly added with a machine code 822 for calling the system call, a machine code 823 which reads out variables from the stack, and a machine code 824 which saves variables into the stack.

Specifically, the branch point of if processing indicated in the source code 702 is determined as the switch point, and thus, adding the machine code 822 to the machine code 812 executes the system call for switching between the processors. Here, an identifier of a program address adr1 is stored in the register REG0. If there is no processor switch request at the execution of the system call, the machine code 812 acquires the program address adr1 from the identifier and executes processing indicated by the acquired program address adr1.

The machine code 823 is a code which is added to the machine code 812 to read out the variables i and j stored in the stack by the machine code 821. Since the values are stored in the registers in the typical program, the values need not be read out from the stack, while in the switchable program, the values need be read out from the stack because the values are saved in the stack in view of the possibility that the processors may be switched therebetween.

The machine code 824 is a code which stores into the stack the values of the register REG1, in which the addition result of the variables i and j is stored, is stored. This is due to the similar reason to the machine code 821.

A machine code 813 corresponds to the source code 703. As compared to the machine code 803, the machine code 813 is newly added with a machine code 825 for calling the system call, a machine code 826 which reads out variables from the stack, and a machine code 827 which saves variables into the stack. The machine codes 825, 826, and 827 are the same as the machine codes 822, 823, and 824, respectively, included in the machine code 812. Thus, the description will be omitted herein.

The beginning of the iterative process is determined as the switch point and the machine code 825 is inserted thereat. In contrast, a branch, while is included in halfway through the iterative process, is not determined as a candidate for switch point. This is to prevent an increase of processing load due to a fact that the system call is called at every iteration.

A machine code 814 corresponds to the source code 704. As compared to the machine code 804, the machine code 814 is newly added with a machine code 828 for calling the system call, and a machine code 829 which reads out variables from the stack. The machine codes 828 and 829 are the same as the machine codes 822 and 823, respectively, included in the machine code 812. Thus, the description will be omitted herein.

Thus, determining the branch as the switch point can facilitate the processor switching. For example, managing the branch target addresses in association among the plurality of processors allows the processor switched to to acquire a corresponding branch target address, thereby facilitating the continuation of the processing. Moreover, this can prevent the switch decision process from being performed at every iteration in the iterative process, thereby reducing the slowdown of processing.

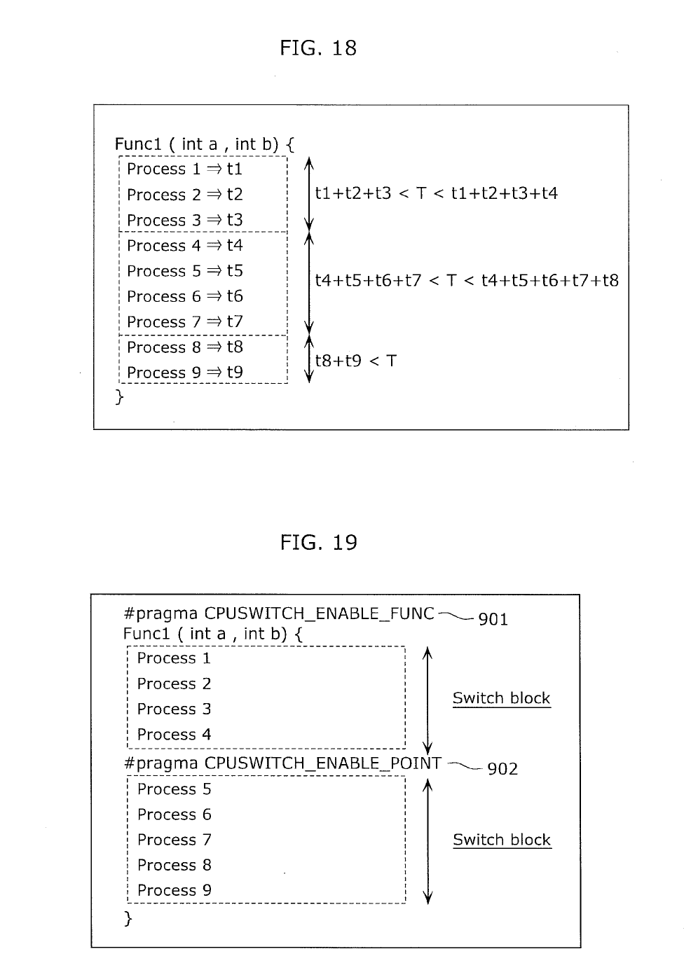

The switch point determination units 301 and 311 according to the embodiment of the present invention may determine the switch point so that a time period required to take a process included between adjacent switch points to be performed is shorter than a predetermined time period. Preferably, the switch point determination units 301 and 311 may determine the switch point so that a time period required to take a process between the switch points to be performed is a period of time. Specific example will be described, with reference to FIG. 18.

FIG. 18 is a diagram illustrating an example where the switch points are determined at predetermined intervals according to the variation of the embodiment of the present invention.

A subroutine Func1 includes processes 1 to 9. Time periods required to take the processor to perform the processes 1 to 9 are t1 to t9, respectively.

The switch point determination units 301 and 311 add time periods required for processes, in order of executing the processes. Then, if the added time period exceeds a predetermined time period T, the switch point determination units 301 and 311 determine the beginning of a process corresponding to the last-added time period as the switch point.

In the example shown in FIG. 18, while the time period (t1+t2+t3) required to perform the processes 1 up to 3 is shorter than the time period T, the time period (t1+t2+t3+t4) required to perform the processes 1 up to 4 is longer than the time period T. Thus, the switch point determination units 301 and 311 determine the beginning of the process 4, which corresponds to the last-added t4, as the switch point. Likewise, the beginning of the process 8 is also determined as the switch point.

It should be noted that the switch point determination units 301 and 311 may determine as the switch point the end of a process corresponding to a time period added the second to last. In this case, in the example shown in FIG. 18, the end of the process 3 and the end of the process 7 are determined as the switch points.

Thus, the switch points are determined at substantially predetermined time intervals. Therefore, an increase of a wait time until the processors are actually switched upon the processor switch request can be prevented.

Moreover, the switch point determination units 301 and 311 according to the embodiment of the present invention may determine a predetermined location in the source program as the switch point. In other words, the switch point determination units 301 and 311 may determine a position predetermined by a user (such as a programmer) in the source program as the switch point. This allows the user to specify the processor switch point. Specific example will be described, with reference to FIG. 19.

FIG. 19 is a diagram illustrating an example in which the switch point is determined by user designation according to the variation of the embodiment of the present invention.

By the user adding a source code for designating a switch point at a predetermined location in the source program, the predetermined location can be designated as the switch point. For example, as shown in FIG. 19, the user adds a source codes 901 “#pragma CPUSWITCH_ENABLE_FUNC” and 902 “#pragma CPUSWITCH_ENABLE_POINT” in the source program, thereby designating positions at which the source codes are written as switch points.

The switch point determination units 301 and 311 determine the positions at which the source codes 901 and 902 are written as the switch points by recognizing the source codes 901 and 902. This determines, in the example of FIG. 19, the beginning of the subroutine Func1 and between the processes 4 and 5 as switch points.

Thus, the switch point can be designated by the user in generating the source program. Therefore, the processors can be switched therebetween at a spot intended by the user.

In the above embodiment, the process is performed which determines whether the processor switch is requested, by calling the system call at the switch point. In contrast, the switch decision process insertion units 303 and 313 may insert, rather than the system call, a switch-dedicated program which determines the processor switch request (determination process) into the switchable programs. For example, the switchable-program generation units 302 and 312 may generate the switchable programs so that the call portion or the return portion which is determined as the switch point is replaced by the switch-dedicated program.

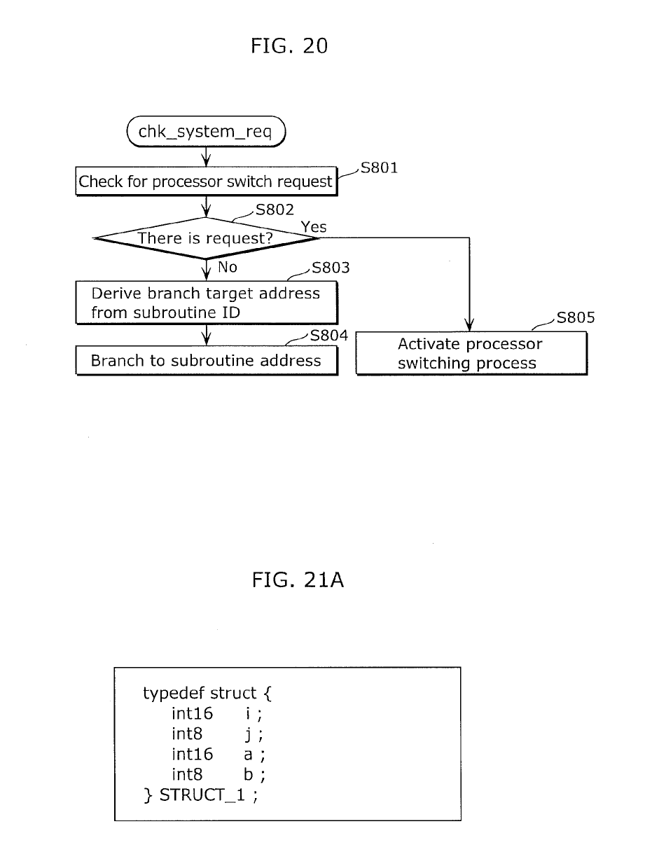

FIG. 20 is a flowchart illustrating an example of a switch request determination process according to the variation of the embodiment of the present invention.

First, the processor checks if the processor switch request is issued from the system controller 130 (specifically, the processor switching control unit 131) (S801). If the processor switch request is issued (Yes in S802), the processor activates the above processor switch sequence illustrated in FIG. 7A (S805).

If the processor switch request is not issued (No in S802), the processor derives a branch target program address (subroutine address) of the subroutine from the address identifier of the subroutine (S803). Then, the processor branches to the subroutine address and initiates the subroutine (S804).

It should be noted that the switch-dedicated program shown in FIG. 20 is the same as the process of the system call (S200) shown in FIG. 5C. In other words, the difference between the switchable program and the switch-dedicated program is that the processor performs the determination process via the system call or performs the determination process in the switchable program rather than via the system call.

Specifically, the switch-dedicated program causes a processor corresponding to the switch-dedicated program to determine whether the processor switch is requested, and if the processor switch is requested, stops the switchable program being executed by the processor corresponding to the switch-dedicated program at the switch point and causes another processor to execute, from the switch point, a switchable program corresponding to the other processor. If the processor switch is not requested, the switch-dedicated program causes the processor corresponding to the switch-dedicated program to continue the execution of the switchable program in execution.

Thus, the switch decision process insertion units 303 and 313 may insert into the switchable programs the switch-dedicated program which performs the switch request determination process, instead of the program which calls the system call.

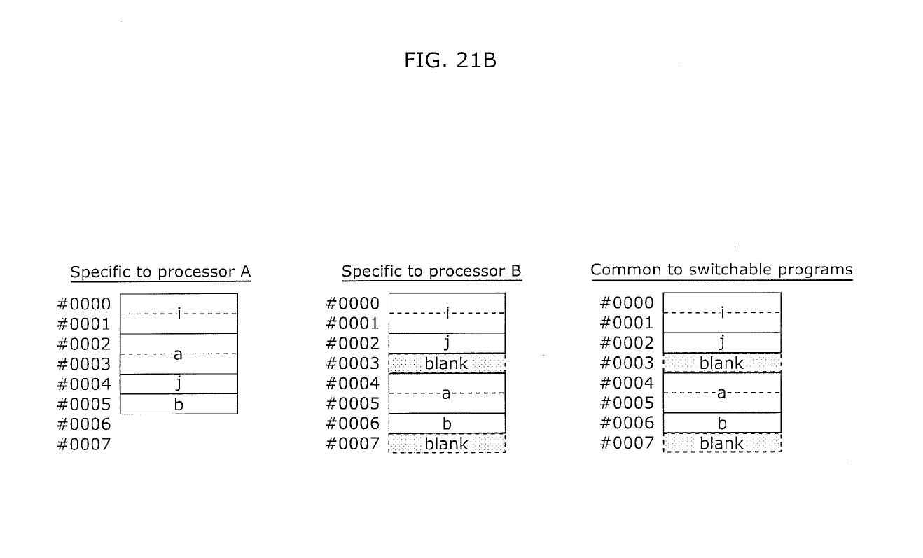

Moreover, preferably, the switchable-program generation units 302 and 312 generate the switchable programs so that the data structure of the structured data stored in the data memory 50 is commonly shared at the switch point among the plurality of processors. Specific example will be described, with reference to FIGS. 21A and 21B.

FIG. 21A is a diagram showing an example of the structured data according to the variation of the embodiment of the present invention. FIG. 21B is a diagram showing an example of the data structure of the structured data according to the variation of the embodiment of the present invention.

As shown in FIG. 21A, the variables i, j, a, and b are defined as structured data in the source program. Herein, the structured data will also be described as a structure variable. Herein, the variables i and a are defined by 16 bits, and the variables j and b are defined by 8 bits.

Herein, for example, as shown in FIG. 21B, an area is reserved in the memory in the program dedicated to the processor A, according to the data width of the defined variable. In other words, a memory area of 16 bits (2 bytes) is reserved for each of the variables i and a of 16 bits, and a memory area of 8 bits (1 byte) is reserved for each of the variables j and b of 8 bits.

In the program dedicated to the processor B, a memory area of 16 bits is reserved for each of all the variables, irrespective of the data width of the variable. In the processor A, the variables i, a, j, and b are stored in the memory in the stated order, while in the processor B, the variables i, j, a, and b are stored in a memory in the stated order. Thus, in the typical program, the size and placement of the data area of the structure variable is different for different processors.

In contrast, in the switchable program according to the variation of the embodiment of the present invention, the data structure of the structure variable is commonly shared among the plurality of processors. Specifically, the size and placement of the data area of the structure variable are commonly shared. This allows any of the processors to read and write the structure variable. Thus, the processors can be switched therebetween.

In the example shown in FIG. 21B, the data structure of the structure variable in the switchable program is, but need not be, the same as the data structure of the structure variable in the program dedicated to the processor B. In other words, the size and placement of the data area of the structure variable may be determined so that the data area is accessed by any of the processors.

Thus, the data structure of the structured data (structure variable) is the same at the switch point as described above. Therefore, the processor switched to can utilize the structured data as it is.

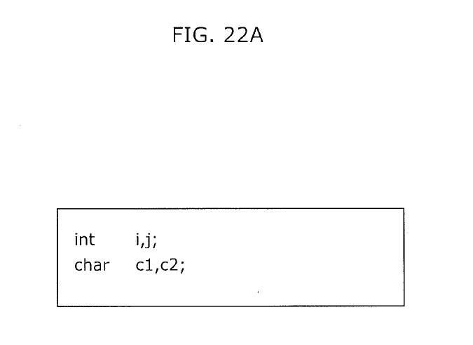

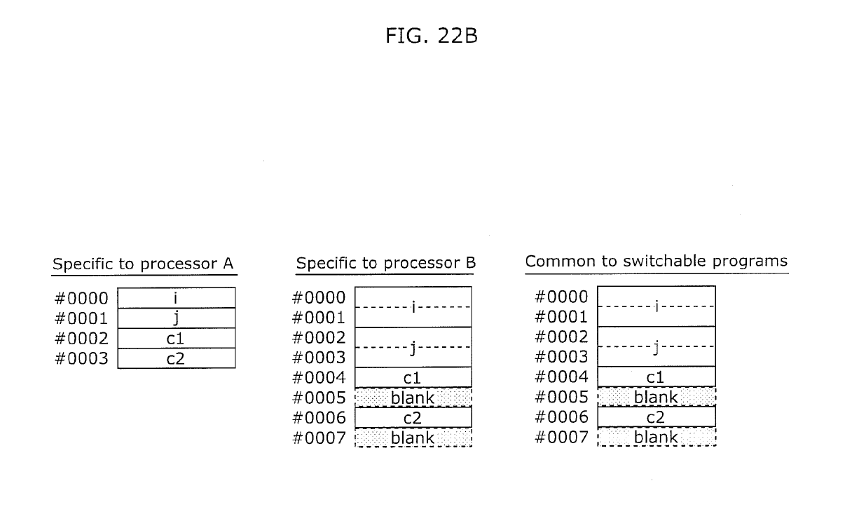

Moreover, preferably, the switchable-program generation units 302 and 312 generate the switchable programs so that the data width of data in which the data width is unspecified in the source program is commonly shared at the switch point among the plurality of processors. Specific example will be described, with reference to FIGS. 22A and 22B.

FIG. 22A is a diagram showing an example of data in which the data width according to the variation of the embodiment of the present invention is unspecified. FIG. 22B is a diagram showing an example of the data structure of data in which the data width according to the variation of the present invention is unspecified.

In the example shown in FIG. 22A, the variables i and j are declared as int, and, the variables c1 and c2 are declared as char. Herein, differently from FIG. 21A, the data width (the number of bits) of each variable is not defined.

Therefore, as shown in FIG. 22B, the processors each uniquely defines the bit width for each variable. Specifically, in the program dedicated to the processor A, a 1-byte area is reserved in the memory for each of the variables i, j, c1, and c2. In the program dedicated to the processor B, a 2-byte area is reserved in the memory for each of the variables i and k, and a 1-byte area is reserved in the memory for each of the variables c1 and c2.

In contrast, in the switchable programs according to the variation of the embodiment of the present invention, the data structure of data in which the data width is unspecified is commonly shared among the plurality of processors. Specifically, the size and placement of the data area of such data are commonly shared. This allows any of the processors to read and write data. Thus, the processors can be switched therebetween.

It should be noted that in the example shown in FIG. 22B, the data structure of data in which the data width is unspecified in the switchable programs is, but need not be, the same as the data structure in the program dedicated to the processor B. In other words, the size of the data area of data in which the data width is unspecified may be determined so that the data area is accessed by any of the processors.

Thus, the data width of data in which the data width is unspecified is commonly shared at the switch point. Therefore, the processor switched to can utilize the data as it is.

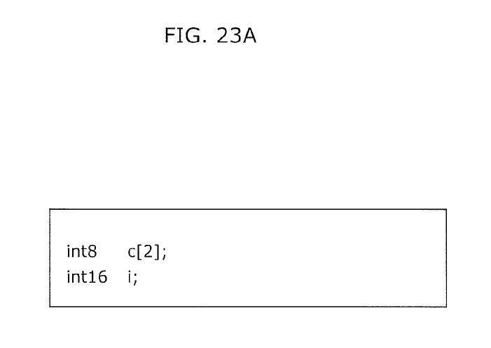

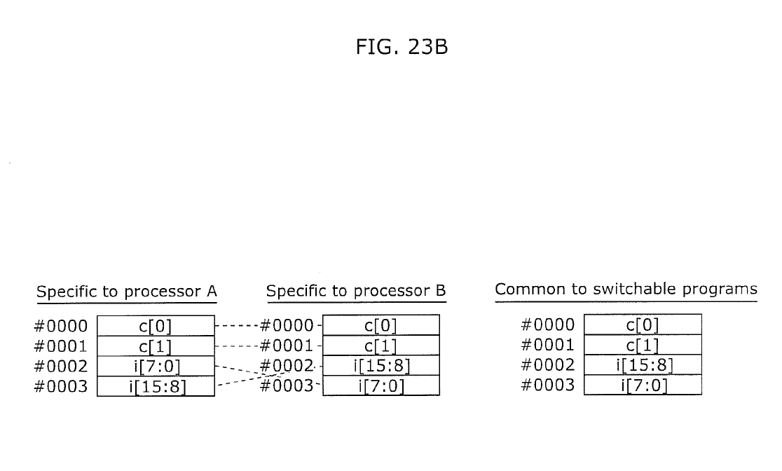

Preferably, the switchable-program generation units 302 and 312 generate the switchable programs so that the endian of the data stored in a memory is commonly shared at the switch point among the plurality of processors. Specific example will be described, with reference to FIGS. 23A and 23B.

FIG. 23A is a diagram showing an example of data according to the variation of the embodiment of the present invention. FIG. 23B is a diagram illustrating the endian of the data according to the variation of the present invention commonly shared among the plurality of processors.

The endian indicates a kind of a method for placing multiple bytes of data in a memory. Specifically, the endian includes big-endian in which a higher order byte is placed in memory at the smallest address, and little-endian in which a lower order byte is placed in memory at the smallest address. The endian is different for different processors.

In the example shown in FIG. 23A, the variable i is 16-byte data. In the program dedicated to the processor A, a lower order bit i[7:0] of the variable i is stored in an address #0002 and a higher order bit i[15:8] of the variable is stored in the address #0003 of the memory, according to little-endian. In the program dedicated to the processor B, on the other hand, a higher order bit i[15:8] of the variable i is stored in the address #0002 and a lower order bit i[7:0] of the variable i is stored in the address #0003 of the memory, according to big-endian.

In contrast, in the switchable program according to the variation of the embodiment of the present invention, the endian is commonly shared among the plurality of processors. Here, when the endian for use in the switchable programs is different from the endian utilized by a processor, a machine code for sorting the read data items is inserted into a switchable program that corresponds to the processor. This allows any of the processors to read/write data. Thus, the processors can be switched therebetween.

In the example shown in FIG. 23B, the endian in the switchable programs and the endian in the program dedicated to the processor B are, but need not be, the same. In other words, the endian may be determined so that the data area is accessed by any of the processors.

Thus, the endian of the data is commonly shared at the switch point. Therefore, the processor switched to can utilize the data read out from the memory as it is if the endian of the own processor and the commonly shared endian are the same. Moreover, if the endian of the own processor is different from the commonly shared endian, the processor switched to can utilize the data items read out from the memory by reordering the read data items.

Moreover, the switchable-program generation units 302 and 312 may control common sharing the data structure of the memory, according to the level of the subroutine. Specifically, the switchable-program generation units 302 and 312 generate the switchable programs so that the subroutine which is a candidate for switch point and an upper subroutine of the subroutine commonly share the data structure of the stack area of the data memory 50.

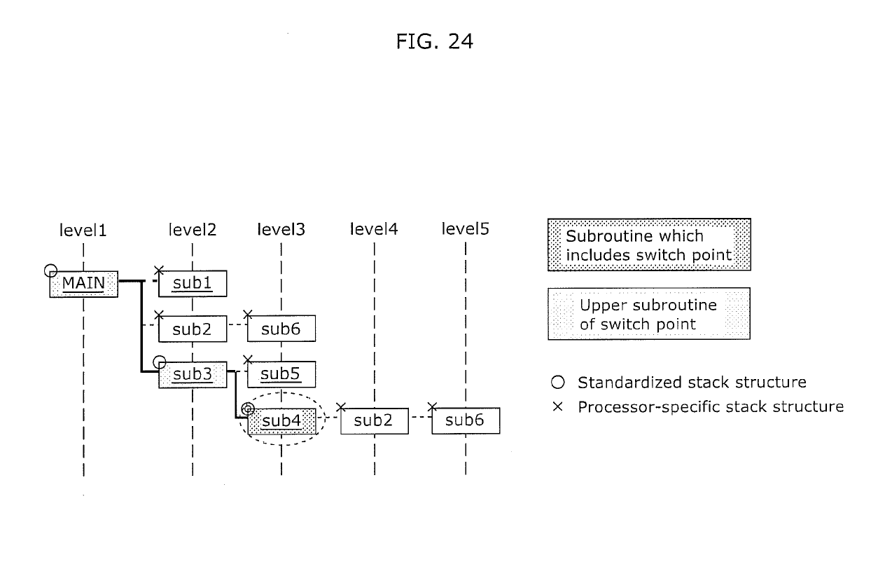

FIG. 24 is a diagram illustrating an example of a process in which the data structure in which the data structure of the memory is commonly shared according to the level of the subroutine according to the variation of the present invention.

In FIG. 24, the case is shown, by way of example, where a subroutine sub4 is determined as a candidate for switch point. In this case, the switchable-program generation units 302 and 312 perform processes so that the data structure of the stack area of the memory is commonly shared between a subroutine sub3 which is an upper subroutine of the subroutine sub4, the main routine MAIN, and the subroutine sub4.

The upper subroutine of the target subroutine is a subroutine between the target subroutine and the main routine in a hierarchical tree of subroutines as shown in FIG. 24, and is located on a route (a route having no branch). Specifically, the upper subroutine includes a subroutine from which the target subroutine is called and a further upper subroutine from which the subroutine is called.

It should be noted that a subroutine lower than the target subroutine does not include subroutines which are candidates for switch points. Therefore, when the lower subroutine is executed, the data structure is restored upon the end of the execution. Thus, the data structure need not be commonly shared.

On the other hand, if a subroutine upper than the target subroutine is executed using a data structure different from that of the target subroutine, the upper subroutine cannot be executed properly upon return to the upper subroutine after the execution of the target subroutine, due to inconsistency of data. Therefore, it is necessary that the data structure is commonly shared between the upper subroutine and the target subroutine.

Herein, for calling and returning from the target subroutine, the processes illustrated in FIGS. 5C and 6C, respectively, are performed. For calling and returning from the upper subroutine which is not a candidate for switch point, the process is performed so that a stack structure is commonly shared, and the processes illustrated in FIGS. 5B and 6B, respectively, are performed. It should be noted that the data structure need not be commonly shared for subroutines branching off from the upper subroutine.

Thus, the data is consistent between the target subroutine and its upper subroutine, and the upper subroutine can be executed properly.

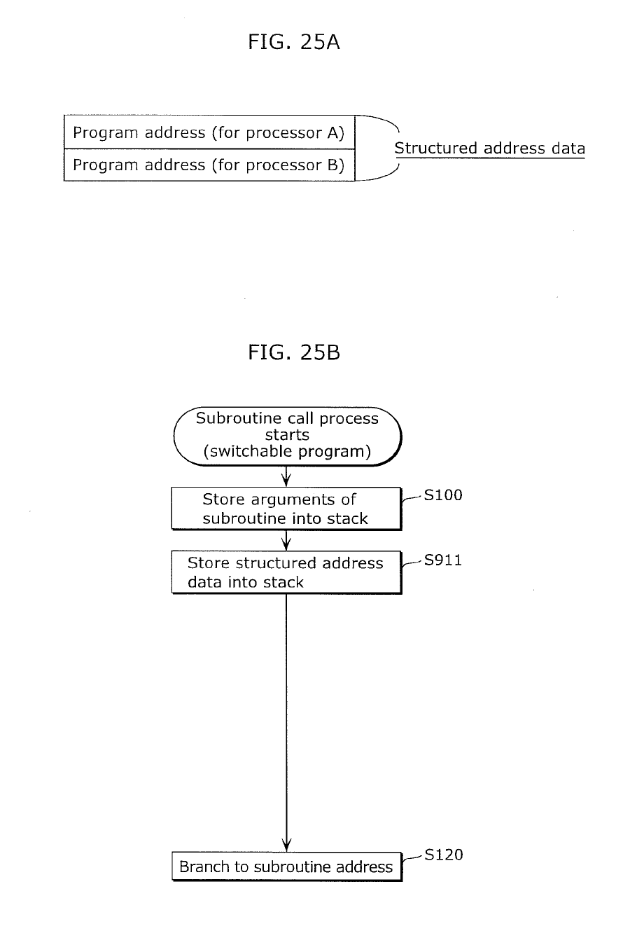

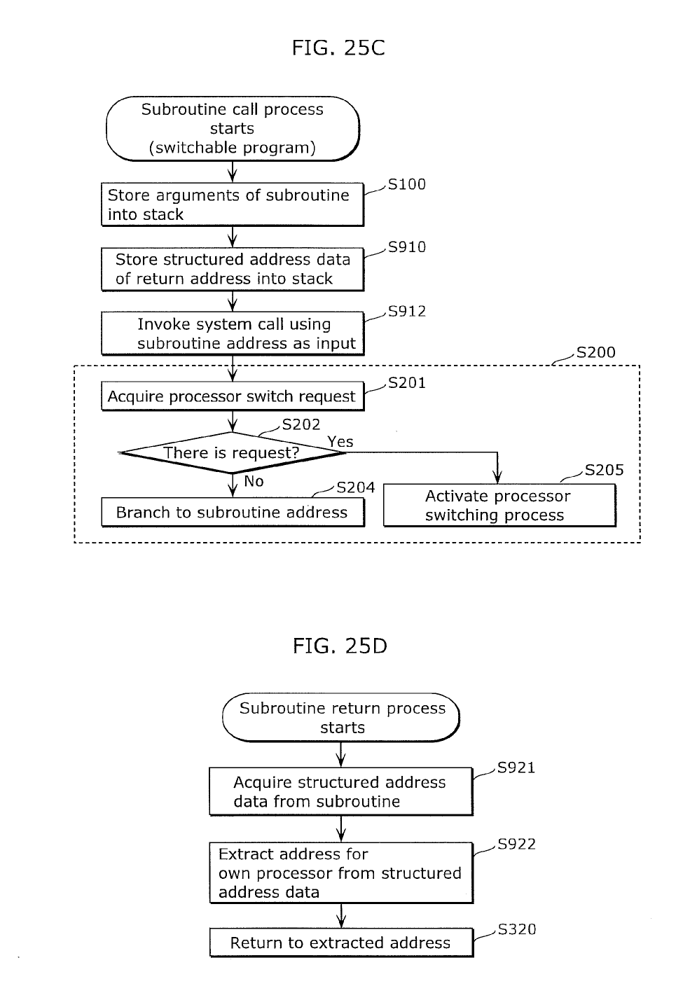

While in the above embodiment, the program address lists in which the branch target address and the identifier are associated with each other are generated as shown in FIGS. 4A and 4B, the switchable-program generation units 302 and 312 may generate structured address data in which the branch target addresses in the switchable programs of the plurality of processors are associated with each other. Specific example will be described, with reference to FIGS. 25A, 25B, 25C, and 25D.

FIG. 25A is a diagram showing an example of the structured address data according to the variation of the embodiment of the present invention.

The switchable-program generation units 302 and 312 generate the structured address data in which the branch target addresses, which are branch target addresses indicating the same branch in the source program and in the switchable programs of the plurality of processors, are associated with each other. The generated structured address data is stored in, for example, the data memory 50.

A program address for the processor A shown in FIG. 25A is one of branch target addresses in the source code, indicating a branch target address in the switchable program A which is a machine program. Likewise, a program address for the processor B is one of branch target addresses in the source code, indicating a branch target address in the switchable program B which is a machine program.

Herein, the program address for the processor A and the program address for the processor B correspond to the same branch target address in the source code. In other words, the processor A120 and the processor B121 each read out the structured address data shown in FIG. 25A, and utilizes a program address corresponding to the own processor, thereby achieving a desired process. For example, when the process is switched from the processor A120 to the processor B121, the processor B121 reads out the structured address data to be read out by the processor A120, and utilizes the program address for the processor B in the read structured address data, thereby continuing the processing from the switch point.

FIG. 25B is a flowchart illustrating an example of the switchable program of the caller of the subroutine according to the variation of the embodiment of the present invention. FIG. 25B corresponds to the flowchart illustrated in FIG. 5B, showing an example where the subroutine call is not determined as the processor switching point.

In the caller of the subroutine, the processor first stores arguments, which are input, into the stack (S100). Then, the processor stores, as the return from the subroutine, the structured address data shown in FIG. 25A, rather than a program address immediately after the subroutine call portion (S911). Then, the processor branches to the start address of the subroutine, and initiates the subroutine (S120).

FIG. 25C is a flowchart illustrating an example of the switchable program of the caller of the subroutine according to the variation of the embodiment of the present invention. FIG. 25C corresponds to the flowchart illustrated in FIG. 5C, showing an example where the subroutine call is determined as the processor switching point.

In the caller of the subroutine, the processor first stores arguments, which are input, into the stack (S100), and stores the structured address data into the stack (S911). Thereafter, the processor extracts a program address for the own processor from the structured address data, and invokes the system call (S200) using the extracted program address as input (S912).

It should be noted that the processing of the system call is substantially the same as shown in FIG. 5C. Thus, the description will be omitted herein. In the example of FIG. 25C, unlike FIG. 5C, the program address is acquired rather than the identifier, and thus the process (S203) which derives the branch target address from a subroutine ID is omitted.

FIG. 25D is a diagram showing an example of a program for the return process from the subroutine according to the variation of the embodiment of the present invention.

First, the processor acquires the structured address data from the stack (S921). In other words, the processor acquires the structured address data which includes the return address from the subroutine. Then, the processor extracts a program address for the own processor from the structured address data (S922). Then, the processor returns to the subroutine return address (S320).

Thus, in the variation according to the embodiment of the present invention, corresponding program addresses may collectively be managed as the structured address data, without using the identifiers. In other words, the structured address data is managed in which the respective branch target addresses of the plurality of processors are associated with each other.

This allows the processor switched to to acquire the branch target address corresponding to the own processor by acquiring the structured address data which includes the branch target address in a process scheduled to be subsequently executed by the processor switched from. Thus, the processor switched to can continue the execution of a task which has been performed by the processor switched from.

The switch decision process insertion units 303 and 313 may insert dedicated processor instructions instead of the system call calling instruction. For example, the switchable-program generation units 302 and 312 may generate the switchable programs so that instructions at the call portion or instructions at a return portion determined as the switch point is replaced by the dedicated processor instructions when the program reaches the determined call portion or the determined return portion.

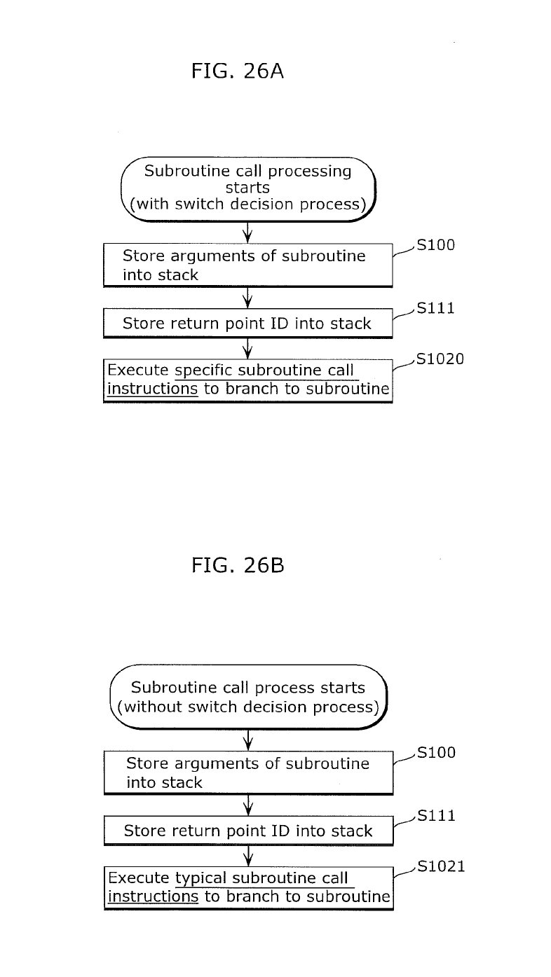

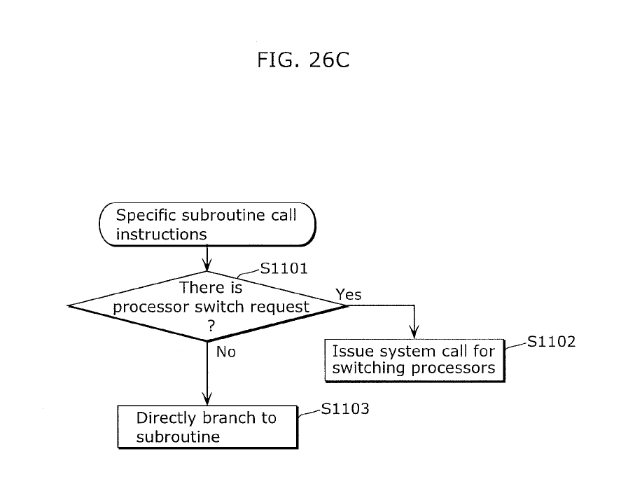

Herein, the dedicated processor instructions invoke execution of the subroutine which determines whether the processor switching is requested. Specific example will be described, with reference to FIGS. 26A, 26B, and 26C.

FIG. 26A is a flowchart illustrating an example of the switchable program of the caller of the subroutine according to the variation of the embodiment of the present invention. FIG. 26A corresponds to the flowchart illustrated in FIG. 5C, showing an example where the subroutine call is determined as the processor switching point.

In the caller of the subroutine, the processor first stores arguments, which are input, into the stack (S100). Then, as the return from the subroutine, the processor stores into the stack the identifier of the program address lists described with reference to FIGS. 4A and 4B as the return point ID, rather than the program address itself which is immediately after the subroutine call portion (S111).

Then, the processor executes specific subroutine call instructions to branch to the subroutine (S1020). The specific subroutine call instructions are by way of example of the dedicated processor instructions and will be described below, with reference to FIG. 26C.

FIG. 26B is a flowchart illustrating an example of the switchable program of the caller of the subroutine according to the variation of the embodiment of the present invention. FIG. 26B corresponds to the flowchart illustrated in FIG. 5B, showing an example where the subroutine call is not determined as the processor switching point.

In the caller of the subroutine, the processor first stores arguments, which are input, into the stack (S100). Then, as the return from the subroutine, the processor stores the identifier of a program address in the program address lists described with reference to FIGS. 4A and 4B as the return point ID, rather than the program address itself which is immediately after the subroutine call portion (S111).

Then, the processor executes the typical subroutine call instructions to branch to the subroutine (S1021). The typical subroutine call instructions are a typical subroutine call conventionally utilized, and the processor branches to the branch target address of the subroutine.

FIG. 26C is a flowchart illustrating an example of the specific subroutine call instructions according to the variation of the embodiment of the present invention.

Once executed the specific subroutine call instructions, the processor first determines whether the processor switch request is issued (S1101). If the processor switch request is issued (Yes in S1101), the processor issues the system call for switching the processor (S1102). The system call, herein, is a system call for activating the processor switching process, for example, and does not include the switch request determination process and the like.

If the processor switch request is not issued (No in S1101), the processor directly branches to the subroutine (S1103). In other words, herein, since the system call using the subroutine ID as input is not made, the branch target address can be utilized as it is.

Thus, the switch program is the dedicated processor instructions. Therefore, the switch program can be executed by execution of the processor instructions. Due to this, as compared to the insertion of the program which calls the system call, the use of the dedicated processor instructions can reduce overhead upon the processor switch determination when there is no processor switch request.

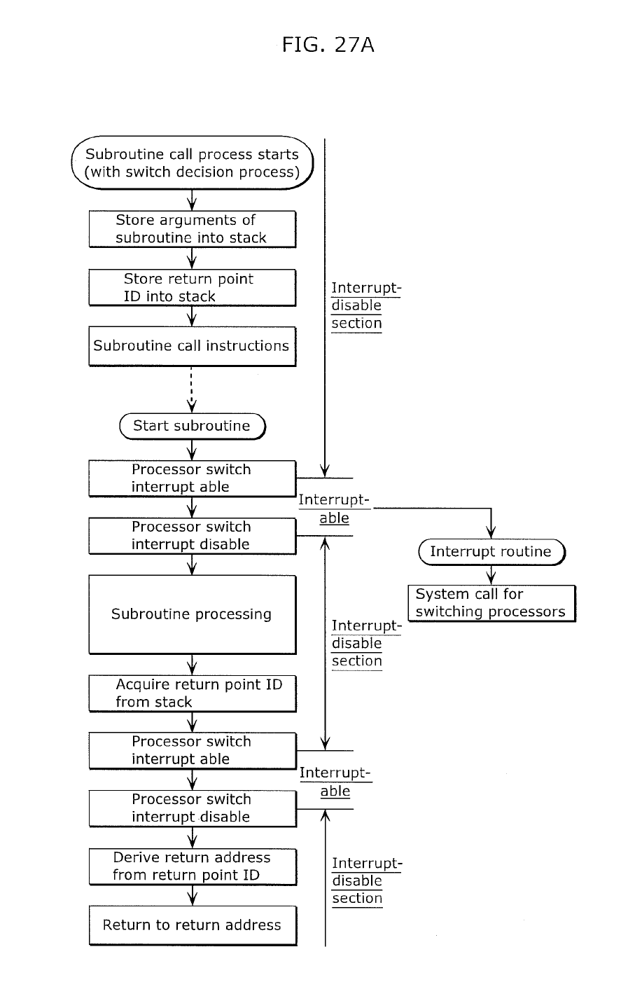

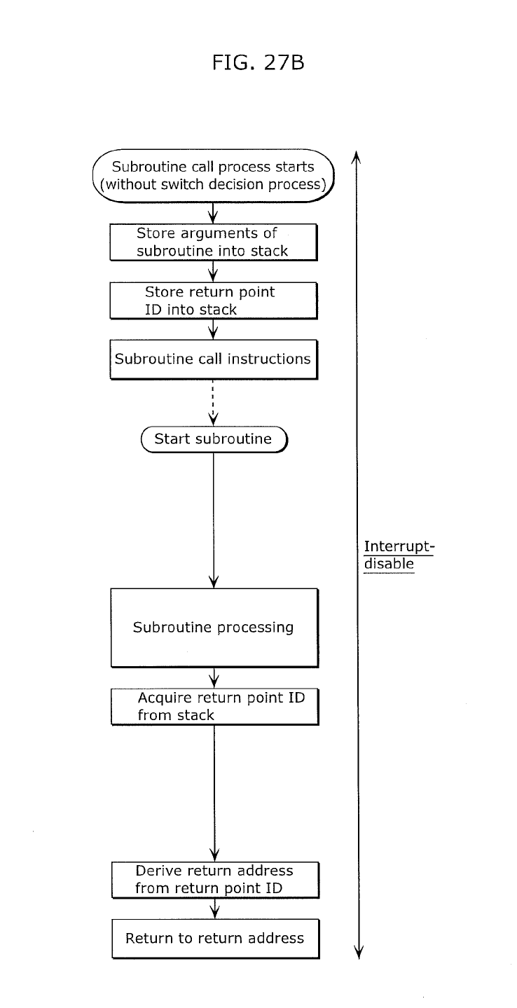

Moreover, the switchable-program generation units 302 and 312 may set a predetermined time period, which has the switch point included therein, as an interrupt-able section in which the processor switch request can be accepted. Furthermore, the switchable-program generation units 302 and 312 may set sections other than the interrupt-able section as interrupt-disable sections in which the processor switch request is not accepted. Specific example will be described, with reference to FIGS. 27A and 27B.

FIG. 27A is a diagram showing an example of the interrupt-able section and interrupt-disable section according to the variation of the embodiment of the present invention. FIG. 27B is a diagram showing an example of the interrupt-disable section according to the variation of the embodiment of the present invention.

As shown in FIG. 27A, the switchable-program generation units 302 and 312 generate the switchable programs so that the interrupt-able sections are set at the boundaries of the subroutine, that is, before and after the subroutine processing. When received the processor switch request from the system controller 130, the processor executing the switchable program, uses an interrupt routine and executes the system call for switching the processor when the switchable program reaches the interrupt-able section. In other words, when received the processor switch request in the interrupt-disable section, the processor continues the execution of the switchable program in execution, and executes the system call in the interrupt-able section.

If the boundaries of the subroutine are not determined as the switch points, the entire section from the subroutine call to the return from the subroutine may be the interrupt-disable section, as shown in FIG. 27B.

It should be noted that the interrupt-able section is not limited to before and after the subroutine processing. In other words, the interrupt-able section can be set at any portion where the processor switching process can be executed.

Moreover, the above interrupt-disable and able may be set only for interruption for the processor switching process, and alternatively, for all interruption processes.

Thus, providing the interrupt-able section can define a section in which the processors can be switched therebetween, thereby preventing the switch at an unintended position.

Moreover, while the example has been described where the processor device according to the above embodiment includes the plurality of processors (i.e., heterogeneous processors) having different instruction sets, the processor may include processors (i.e., homogeneous processors) having a common instruction set. For example, the present invention is applicable to the case where different compilers (program generation devices) generate machine programs for a plurality of homogeneous processors. This allows the processors to be switched therebetween even during the execution of a task, thereby accommodating changes in statuses of system and use case.

Moreover, while the example has been described where the program generation device according to the above embodiment includes the plurality of different compilers, the program generation device may include one compiler. In this case, the compiler generates two machine programs including the machine program for the processor A and the machine program for the processor B.

Moreover, the registers may be commonly shared among the plurality of processors. In other words, the switchable-program generation units may generate programs for taking over at the switch point the data stored in the registers included in the first processor currently executing a program to the registers included in the second processor.

Specifically, the processor reads out the values in the registers included in the first processor, which is the processor switched from, and stores the read values into the registers included in the second processor which is the processor switched to. For example, the read from the register is performed in step S501 of FIG. 7A, and the write to the register is performed in step S512 of FIG. 7B. Preferably, the first processor and the second processor have the same number of registers.

Moreover, while the switch between two processors has been described with reference to the above embodiment, the switch may be performed between three or more processors.

Moreover, when generating the switchable programs, the program generation device according to the present embodiment may generate the programs separately, based on greatest rules common in creating programs for individual processors according to common rules. Alternatively, the program generation device may employ a method which first generates one program and tune another program to the generated program.

The processing components included in the program generation device or the processor device according to the above embodiment are each implemented typically in an LSI (Large Scale Integration) which is an integrated circuit. These processing components may separately be mounted on one chip, or a part or the whole of the processing components may be mounted on one chip.

Here, the term LSI is used. However, IC (Integrated Circuit), system LSI, super LSI, ultra LSI may be used depending on the difference in degree of integration.

Moreover, the integrated circuit is not limited to the LSI and may be implemented in a dedicated circuit or a general-purpose processor. An FPGA (Field Programmable Gate Array) which is programmable after manufacturing the LSI, or a reconfigurable processor in which connection or settings of circuit cells in LSI is reconfigurable may be used.

Furthermore, if circuit integration technology emerges replacing the LSI due to advance in semiconductor technology or other technology derived therefrom, the processing components may, of course, be integrated using the technology. Application of biotechnology is conceivably possible.

Moreover, a part or the whole of the functionality of the program generation device or the processor device according to the embodiment of the present invention may be implemented by a processor such as CPU executing a program.

Furthermore, the present invention may be the above-described program or a storage medium having stored therein the program. Moreover, the program can, of course, be distributed via transmission medium such as the Internet.

Moreover, numerals used in the above are merely illustrative for specifically describing the present invention and the present invention is not limited thereto. Moreover, the connection between the components is merely illustrative for specifically describing the present invention and connection implementing the functionality of the present invention is not limited thereto.

Furthermore, the above embodiment is configured using hardware and/or software, the configuration using hardware can also be configured using software, and the configuration using software can also be configured using hardware.

Moreover, the configurations of the program generation device, the processor device, and the multiprocessor system described above are merely illustrative for specifically describing the present invention, and the program generation device, the processor device, and the multiprocessor system according to the present invention may not necessarily include all of the configurations. In other words, the program generation device, the processor device, and the multiprocessor system according to the present invention may include minimum configurations that can achieve the advantageous effects of the present invention.

Likewise, the program generation method according to the above described program generation device is merely illustrative for specifically describing the present invention, and the program generation method by the program generation device according to the present invention may not necessarily include all the steps. In other words, the program generation method according to the present invention may include minimum steps that can achieve the advantageous effects of the present invention. Moreover, the order in which the steps are performed is merely illustrative for specifically describing the present invention, and may be performed in an order other than as described above. Moreover, part of the steps described above may be performed concurrently (in parallel) with another step.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention has advantageous effects of allowing processors to be switched therebetween even during execution of a task, can accommodate changes in statuses of system and use case, and is applicable to, for example, compilers, processors, computer systems, and household appliances.

1. A program generation device for generating, from a same source program, machine programs corresponding to plural processors having different instruction sets and sharing a memory, the program generation device comprising:
a switch point determination unit configured to determine a predetermined location in the source program as a switch point;
a program generation unit configured to generate for each processor a switchable program, which is the machine program, from the source program so that a data structure of the memory is commonly shared at the switch point among the plural processors; and
an insertion unit configured to insert into the switchable program a switch program for stopping at the switch point a switchable program, among the switchable programs, being executed by and corresponding to a first processor that is one of the plural processors, and causing a second processor that is one of the plural processors to execute, from the switch point, a switchable program, among the switchable programs, corresponding to the second processor.

2. The program generation device according to claim 1, further comprising
a direction unit configured to direct generation of the switchable programs,
wherein the switch point determination unit is configured to determine the switch point when the direction unit directs the generation of the switchable programs,
the program generation unit is configured to generate the switchable programs when the direction unit directs the generation of the switchable programs, and
the insertion unit is configured to insert the switch program into the switchable programs when the direction unit directs the generation of the switchable programs.

3. The program generation device according to claim 2,
wherein when the direction unit does not direct the generation of the switchable programs, the program generation unit is configured to generate for each processor a program which can be executed only by a corresponding processor among the plural processors, based on the source program.

4. The program generation device according to claim 1,
wherein the switch point determination unit is configured to determine at least a portion of boundaries of a basic block of the source program as the switch point.

5. The program generation device according to claim 4,
wherein the basic block is a subroutine of the source program, and
the switch point determination unit is configured to determine at least a portion of boundaries of the subroutine of the source program as the switch point.

6. The program generation device according to claim 5,
wherein the switch point determination unit is configured to determine a call portion of a caller of the subroutine as the switch point, the call portion being the at least a portion of the boundaries of the subroutine.

7. The program generation device according to claim 5,
wherein the switch point determination unit is configured to determine at least one of beginning and end of a callee of the subroutine as the switch point, the at least one of the beginning and end of the callee being the at least a portion of the boundaries of the subroutine.

8. The program generation device according to claim 5,
wherein the switch point determination unit is configured to determine, as the switch point, at least a portion of the boundaries of the subroutine at which a depth of a level at which the subroutine is called in the source program is shallower than a predetermined threshold.

9. The program generation device according to claim 1,
wherein the switch point determination unit is configured to determine at least a portion of a branch in the source program as the switch point.

10. The program generation device according to claim 9,
wherein the switch point determination unit is configured to exclude a branch to an iterative process in the source program from a candidate for the switch point.

11. The program generation device according to claim 1,
wherein the switch point determination unit is configured to determine the switch point so that a time period required for execution of a process included between adjacent switch points is shorter than a predetermined time period.

12. The program generation device according to claim 1,
wherein the switch point determination unit is configured to determine a predefined location in the source program as the switch point.

13. The program generation device according to claim 1,
wherein the program generation unit is configured to generate the switchable programs so that a data structure of a stack of the memory is commonly shared at the switch point among the plural processors.

14. The program generation device according to claim 13,
wherein the program generation unit is configured to generate the switchable programs so that a data size and placement of data stored in the stack of the memory is commonly shared at the switch point among the plural processors.

15. The program generation device according to claim 1,
wherein the program generation unit is configured to generate the switchable programs so that a data structure in structured data stored in the memory is commonly shared at the switch point among the plural processors.

16. The program generation device according to claim 1,
wherein the program generation unit is configured to generate the switchable programs so that a data width of data in which the data width is unspecified in the source program is commonly shared at the switch point among the plural processors.

17. The program generation device according to claim 1,
wherein the program generation unit is configured to generate the switchable programs so that a data structure of data globally defined in the source program is commonly shared at the switch point among the plural processors.

18. The program generation device according to claim 1,
wherein the program generation unit is configured to generate the switchable programs so that endian of data stored in the memory is commonly shared at the switch point among the plural processors.

19. The program generation device according to claim 1,
wherein the program generation unit is further configured to
provide an identifier common to branch target addresses, which indicate a same branch in the source program and are in the switchable programs of the plural processors, and generate an address list in which the identifier and the branch target addresses are associated with each other, and
replace a process of storing the branch target addresses in the switchable programs into the memory by a process of storing an identifier corresponding to the branch target addresses into the memory.

20. The program generation device according to claim 1,
wherein the program generation unit is further configured to generate structured address data in which branch target addresses, which indicate a same branch in the source program and are in the switchable programs of the plural processors, are associated with each other.

21. The program generation device according to claim 1,
wherein the plural processors each include at least one register, and
the program generation unit is configured to generate the switchable programs including a process of storing into the memory a value which is stored in the register before the switch point and utilized after the switch point.

22. The program generation device according to claim 1,
wherein the program generation unit is configured to generate the switchable programs so that a data structure of a stack of the memory is commonly shared between a target subroutine, which is a subroutine including the boundary determined as the switch point by the switch point determination unit, and an upper subroutine of the target subroutine.

23. The program generation device according to claim 1,
wherein the insertion unit is configured to insert into the switchable programs a program which calls a system call which is the switch program.

24. The program generation device according to claim 1,
wherein the program generation unit is further configured to generate a switch-dedicated program for each processor,
the switch-dedicated program:
causing a processor, among the plural processors, corresponding to the switch-dedicated program to determine whether a processor switch is requested;
when the processor switch is requested, stopping a switchable program, among the switchable programs, being executed by the processor corresponding to the switch-dedicated program at the switch point, and causing the second processor to execute from the switch point a switchable program, among the switchable programs, corresponding to the second processor; and
when the processor switch is not requested, causing continuous execution of the switchable program being executed by the processor corresponding to the switch-dedicated program, and
the insertion unit is configured to insert the generated switch-dedicated programs as the switch programs into the switchable programs.

25. The program generation device according to claim 24,
wherein the switch-dedicated program is configured as a subroutine, and
the insertion unit is configured to insert a subroutine call at the switch point.

26. The program generation device according to claim 25,
wherein the switch point determination unit is configured to determine as the switch point a call portion of a caller of the subroutine of the source program or a return portion from the subroutine of the source program, and
the program generation unit is configured to generate the switchable programs so that the call portion or the return portion determined as the switch point is replaced by the switch-dedicated program.

27. The program generation device according to claim 23,
wherein the switch-dedicated program includes processor instructions dedicated to each of the plural processors, and
the insertion unit is configured to insert the dedicated processor instructions at the switch point.

28. The program generation device according to claim 27,
wherein the switch point determination unit is configured to determine as the switch point the call portion of a caller of the subroutine of the source program or the return portion from the subroutine of the source program, and
the program generation unit is configured to generate the switchable programs so that the call portion or the return portion determined as the switch point is replaced by the dedicated processor instructions.

29. The program generation device according to claim 1,
wherein the program generation unit is further configured to set a predetermined section in which the switch point is included as an interrupt-able section in which the processor switch request can be accepted, and set sections other than the interrupt-able section as interrupt-disable sections in which the processor switch request cannot be accepted.

30. A program generation method for generating, from a same source program, machine programs corresponding to plural processors having different instruction sets and sharing a memory, the program generation method comprising:
determining a predetermined location in the source program as a switch point;
generating for each processor a switchable program, which is the machine program, from the source program so that a data structure of the memory is commonly shared at the switch point among the plural processors; and
inserting into the switchable program a switch program for stopping at the switch point a switchable program, among the switchable programs, being executed by and corresponding to a first processor that is one of the plural processors, and causing a second processor that is one of the plural processors to execute, from the switch point, a switchable program, among the switchable programs, corresponding to the second processor.

31. A non-transitory computer-readable recording medium having stored therein a program for causing a computer to execute the program generation method according to claim 30.

32. A processor device comprising:
plural processors having different instruction sets and sharing a memory, which can execute switchable programs corresponding to the plural processors,
a control unit configured to request a switch among the plural processors,
wherein the switchable programs are machine programs generated from a same source program so that the data structure of the memory is commonly shared at a switch point, which is a predetermined location in the source program, among the plural processors, each of the switchable programs corresponding to each of the plural processors, and
when the switch is requested from the control unit, a first processor which is one of the plural processors executes a switch program for stopping, at the switch point, a switchable program, among switchable programs, being executed by and corresponding to the first processor, and causing a second processor, which is one of the plural processors, to execute from the switch point a switchable program, among switchable programs, corresponding to the second processor.

33. A multiprocessor system comprising:
plural processors having different instruction sets and sharing a memory;
a control unit configured to request a switch between the plural processors; and
a program generation device which generates from a same source program machine programs each corresponding to each of the plural processors,
wherein the program generation device includes:
a switch point determination unit configured to determine a predetermined location in the source program as a switch point;
a program generation unit configured to generate from the source program a switchable program which is the machine program for each processor so that the data structure of the memory is commonly shared at the switch point among the plural processors; and
an insertion unit configured to insert into the switchable program a switch program for stopping at the switch point a switchable program, among the switchable programs, being executed by and corresponding to a first processor which is one of the plural processors, and causing a second processor which is one of the plural processors to execute from the switch point a switchable program, among the switchable programs, corresponding to the second processor, and
the first processor executes the switch program corresponding to the first processor when the switch is requested from the control unit.

34. A non-transitory computer-readable recording medium having stored therein a machine program generated from a source program and executed by a first processor which is one of plural processors having different instruction sets and sharing a memory, the machine program comprising:
a function of performing a process so that a data structure of the memory is commonly shared at a switch point among the plural processors, the switch point being a predetermined location in the source program; and
a function of executing a switch program for stopping the machine program at the switch point and causing a second processor which is one of the plural processors to execute, from the switch point, a machine program generated from the source program and corresponding to the second processor.
